(19) United States
(12) Patent Application Publication
(10) Pub. No.: US 2025/0201847 A1
(43) Pub. Date: Jun. 19, 2025

(54) NEGATIVE ELECTRODE BINDER COMPOSITION AND METHOD FOR PRODUCING THE SAME, NEGATIVE ELECTRODE, AND SECONDARY BATTERY

(71) Applicant: DIC Corporation, Tokyo (JP)

(72) Inventors: Iwao Fukuchi, Chiba (JP); Masahiro Kajikawa, Osaka (JP); Yusuke Matsumura, Osaka (JP); Yoshinobu Kimura, Osaka (JP); Kenichi Kawase, Chiba (JP)

(73) Assignee: DIC Corporation, Tokyo (JP)

(21) Appl. No.: 18/851,785

(22) PCT Filed: Mar. 9, 2023
(86) PCT No.: PCT/JP2023/008947

§ 371 Date: Sep. 27, 2024

(30) Foreign Application Priority Data
Apr. 12, 2022 (JP) 2022-065647

(51) Int. Cl. H01M 4/62; C08F 212/08; C08F 220/06; C08F 220/18; C08F 220/28; C08F 220/56; C08F 220/58; H01M 4/02; H01M 4/133; H01M 4/36; H01M 4/48; H01M 4/587

(52) U.S. Cl. CPC H01M 4/622; C08F 212/08; C08F 220/06; C08F 220/1806; C08F 220/281; C08F 220/56; C08F 220/58; H01M 4/133; H01M 4/364; H01M 4/48; H01M 4/587; H01M 2004/021; H01M 2004/027

(57) ABSTRACT

A negative electrode binder composition and a method for producing the same, a negative electrode containing the negative electrode binder composition, and a secondary battery, in which good battery performance can be obtained when a new active material is used, or the electrode has a thicker film or higher density, are provided. The negative electrode binder composition includes: a water-soluble resin (X) containing a copolymer of a hydroxyl group-containing monomer (a) and an acid group-containing monomer (b); and an aqueous latex resin (Y). The copolymer has a weight average molecular weight of 700,000 or more as measured using an aqueous GPC measuring device and a swelling rate of 0 to 10% by weight after a dried film of the copolymer is immersed in a carbonate-based mixed solvent (ethylene carbonate (EC)/diethylene carbonate (DEC)=50/50 (wt)) at 45° C. for 72 hours.

### TECHNICAL FIELD

The present invention relates to a negative electrode binder composition and a method for producing the same, a negative electrode containing the negative electrode binder composition, and a secondary battery.

### BACKGROUND ART

The binder (bonding agent) in the negative electrode of a lithium-ion secondary battery (which hereinafter may be referred to as “LIB”) is usually a combination of carboxymethyl cellulose sodium salt (CMC), which is a water-soluble polymer, and a styrene-butadiene copolymer (SBR), which is an aqueous latex resin. The main functions of the binder during an electrode fabrication process include: 1) uniformly dispersing an active material, a conductivity aid, and other components; 2) adjusting the rheology of electrode mixture slurry; 3) leveling for planarizing a mixture layer during drying of the applied slurry; and 4) binding mixture components and a current collector. Furthermore, the functions involved with battery performance include: 5) suppressing electrode expansion due to volume change of an active material that occurs during charge-discharge cycles; 6) maintaining bonding between the active material and the current collector to ensure electron conductivity; and 7) ensuring ion conductivity by swelling moderately with electrolyte. LIBs are widely used as rechargeable power sources for notebook computers and mobile phones. In recent years, their use has been rapidly expanding in power tools such as electric tools, and medium and large equipment such as automobiles and stationary power storage facilities. With the rapid expansion of the range of application, the performance required of batteries varies over a wider temperature range, but capacity, output power, and life are three main performance aspects of importance, and improvements in these aspects are particularly desired.

Under these circumstances, various efforts have been made to meet the demand for higher battery performance. For example, in negative electrode materials, in an effort to increase capacity, new negative electrode active materials are being studied as an alternative to carbon-based active materials (e.g., graphite) which have been widely used. Examples of the new negative electrode active materials include tin alloys, silicon alloys, and silicon oxides. These new negative electrode active materials have a capacity several times greater than that of carbon-based active materials, and adding only a small amount can increase the capacity of the negative electrode. However, the problem with these new negative electrode active materials is that their capacity retention rate in charge-discharge cycles is inferior to that of carbon-based active materials. One of the reasons for this is that the new negative electrode active materials have greater volume expansion and contraction with charge and discharge than carbon-based active materials, resulting in loss of the active materials and reduction of electron conductivity due to destruction of the electrode structure. Another reason is that if an SEI film formed on an active material surface fails to follow the volume change and is destroyed, the active material surface not covered by the SEI film is exposed, so that decomposition of the electrolyte proceeds due to a new SEI film formation reaction. The SEI film is mainly composed of decomposition products of the electrolyte and is formed on the active material surface during initial charge. This SEI film is thought to play a role in mediating the insertion/desorption reaction of lithium ions and at the same time suppressing further electrolyte decomposition reactions, thereby contributing to improved battery performance. If the SEI film is too thin, the electrolyte decomposition reaction does not stop. If the SEI film is too thick, the electrical resistance increases, resulting in adverse effects on battery life and efficiency.

In an effort to solve the problem associated with the volume change of the new negative electrode active materials, for example, PTL 1 below proposes a method for suppressing volume change of the negative electrode active material by using high-strength aromatic polyimide as a binder. PTL 2 below proposes a method for suppressing volume change of the negative electrode active material by using partially cross-linked polyacrylic acid as a binder. Furthermore, PTL 3 below proposes a method for suppressing volume change of the negative electrode active material by using a copolymer of acrylic acid and polyvinyl alcohol as a binder. However, the binder in PTL 1 failed to fully fulfill the capacity of the active material due to poor initial charge-discharge efficiency. With the binders in PTLs 2 and 3, the high and low temperature cycling characteristics were not necessarily sufficient.

On the other hand, when the capacity retention rate during charge-discharge cycles is emphasized and a higher capacity is desired, a conventional method that increases the capacity by increasing the weight of active material per unit area is used without changing a graphite-based negative electrode. In this case, either or both of increasing the thickness of the electrode layer (thicker film) and increasing the electrode density (higher density) are required. As the electrode becomes thicker, the distance traveled by electrons and ions inside the electrode increases and their transfer resistance increases. Furthermore, since a higher density reduces voids between active material particles, the flow path of the electrolyte becomes narrower and ion transfer resistance increases. The increase in resistance is a factor that leads to reduced battery performance, resulting in reduction in capacity retention rate and load characteristics.

In an effort to solve the above problems involved with the thicker film and higher density of the electrode, for example, PTL 4 below proposes a method in which a negative electrode is made in two layers, CMC/SBR is used for the lower layer, and an acrylate binder with high electrolyte swelling properties is used for the upper layer. However, the method in PTL 4 is disadvantageous in that it doubles the electrode fabrication process. In addition, there is concern about decrease in cycle characteristics at high temperatures due to a large degree of electrolyte swelling in the upper layer. PTL 5 proposes a method using a mixed resin of PVDF and a resin with an acidic functional group and a polyvinylidene fluoride skeleton as the main chain. However, when a fluorinated resin such as PVDF is used as a binding agent, an organic solvent such as NMP is used as a solvent for slurrying, but it is preferable to use an aqueous solvent for slurrying from recent environmental considerations and from the standpoint of worker safety and price.

### CITATION LIST

### Patent Literature

PTL 1: Japanese Unexamined Patent Application Publication No. 2019-204786
PTL 2: Japanese Unexamined Patent Application Publication No. 2018-029069
PTL 3: Japanese Unexamined Patent Application Publication No. 2021-136121
PTL 4: Japanese Unexamined Patent Application Publication No. 2018-120706
PTL 5: Japanese Unexamined Patent Application Publication No. 2020-113442

### SUMMARY OF INVENTION

### Technical Problem

As described above, the conventional binders in LIB negative electrodes lack the ability to suppress reduction in battery performance caused by the volume expansion of new active materials, or thicker films and higher density of electrodes. An object of the present invention is to provide a negative electrode binder composition and a method for producing the same, a negative electrode containing the negative electrode binder composition, and a secondary battery, in which good battery performance can be achieved even when new active materials are used, or the electrode has a thicker film or higher density.

### Solution to Problem

In order to solve these problems, the inventors of the present invention have conductive elaborate studies and found that by using a resin containing a hydroxyl group and an acid group with an unprecedentedly high molecular weight and an aqueous latex resin for a negative electrode, swelling of the electrode is suppressed, peel strength is high, and good cycle characteristics are exhibited even at high and low temperatures. This finding has led to completion of the present invention.

In other words, the present invention relates to the following.
[1]A negative electrode binder composition including: a water-soluble resin (X) containing a copolymer of a hydroxyl group-containing monomer (a) and an acid group-containing monomer (b) as essential components; and an aqueous latex resin (Y), wherein the copolymer has a weight average molecular weight of 700,000 or more as measured by an aqueous GPC measuring device and a swelling rate of 0 to 10% by weight after a dried film of the copolymer is immersed in a carbonate-based mixed solvent (ethylene carbonate (EC)/diethylene carbonate (DEC)=50/50 (wt)) at 45° C. for 72 hours.
[2] The negative electrode binder composition according to [1], wherein the hydroxyl group-containing monomer (a) is any one or more selected from the group consisting of 2-hydroxyethyl acrylate, 2-hydroxypropyl acrylate, 3-hydroxypropyl acrylate, 2-hydroxybutyl acrylate, 4-hydroxybutyl acrylate, 2-hydroxyethyl methacrylate, 2-hydroxypropyl methacrylate, 3-hydroxypropyl methacrylate, 2-hydroxybutyl methacrylate, and 4-hydroxybutyl methacrylate.
[3] The negative electrode binder composition according to [1] or [2], wherein the acid group-containing monomer (b) is neutralized with a basic composition or a light metal salt.
[4] The negative electrode binder composition according to any one of [1] to [3], wherein the acid group-containing monomer (b) is one or more selected from the group consisting of acrylic acid, methacrylic acid, maleic acid, monomethyl maleic acid, 2-carboxyethyl acrylate, 2-carboxyethyl methacrylate, maleic acid, and itaconic acid.
[5] The negative electrode binder composition according to any one of [1] to [4], wherein the water-soluble resin (X) further contains one or more selected from the group consisting of acrylamide, methacrylamide, N-methylacrylamide, N,N-dimethylacrylamide, and N-hydroxymethylacrylamide.
[6] The negative electrode binder composition according to any one of [1] to [5], wherein a total content of resin components derived from the hydroxyl group-containing monomer (a) and the acid group-containing monomer (b) relative to a total amount of the water-soluble resin (X) is 5 to 80% by weight.
[7] The negative electrode binder composition according to any one of [1] to [6], wherein the one or more selected from the group consisting of acrylamide, methacrylamide, N-methylacrylamide, N,N-dimethylacrylamide, and N-hydroxymethylacrylamide have a content of 0 to 80% by weight.
[8] The negative electrode binder composition according to any one of [1] to [7], wherein the aqueous latex resin (Y) is one or more selected from a SBR, a styrene acrylate copolymer, and an acrylate copolymer.
[9] The negative electrode binder composition according to [8], wherein the styrene acrylate copolymer is butyl acrylate.
[10] The negative electrode binder composition according to [9], wherein a content of a styrene monomer-derived structural unit is 40 to 60% by weight and a content of a butyl acrylate monomer-derived structural unit is 20 to 40% by weight in a total amount of the styrene acrylate copolymer.
[11]A negative electrode containing the negative electrode binder composition according to any one of [1] to [10] as a component.
[12] The negative electrode according to [11], wherein a total content of a component derived from the water-soluble resin (X) and a component derived from the aqueous latex resin (Y) is 1.5% by weight or more and 5.5% by weight or less.
[13] The negative electrode according to [11] or [12], including a graphite-based material as a main active material, wherein the negative electrode has a volume density of 1.4 g/cm³ or more.
[14] The negative electrode according to any one of
[11] to [13], wherein the negative electrode has a mixture layer having a thickness of 80 μm or more.
[15] The negative electrode according to any one of
[11] to [14], including a mixed active material of at least two or more of graphite-based materials and silicon-containing materials.
[16]A secondary battery including the negative electrode according to any one of [11] to [15].
[17]A method for producing a negative electrode binder composition according to any one of [1] to [10], the method including steps of: kneading an aqueous slurry including at least an active material and the water-soluble resin (X); and thereafter reducing a solid content concentration and mixing the aqueous latex resin (Y).

### Advantageous Effects of Invention

The negative electrode binder composition according to the present invention has good slurry stability even without a thickening agent such as cellulose, and a coating formed of the negative electrode binder composition has good resistance to electrolyte swelling at high temperatures. The negative electrode containing the negative electrode binder composition according to the present invention as a component therefore has high peel strength and as a result, exhibits good charge-discharge characteristics even at high cycle counts when battery evaluation is conducted, thereby achieving the performance required of LIB negative electrodes in recent years.

### DESCRIPTION OF EMBODIMENTS

### <Negative Electrode Binder Composition>

A negative electrode binder composition according to the present invention is a negative electrode binder composition including: a water-soluble resin (X) containing a copolymer of a hydroxyl group-containing monomer (a) and an acid group-containing monomer (b) as essential components; and an aqueous latex resin (Y), wherein the copolymer has a weight average molecular weight of 700,000 or more as measured using an aqueous GPC measuring device and a swelling rate of 0 to 10% by weight after a dried film of the copolymer is immersed in a carbonate-based mixed solvent (ethylene carbonate (EC)/diethylene carbonate (DEC)=50/50 (wt)) at 45° C. for 72 hours.

The weight average molecular weight of the copolymer as measured using an aqueous GPC measuring device is 700,000 or more, preferably 750,000 to 1,500,000, more preferably 800,000 to 1,200,000. When the weight average molecular weight is 700,000 or more, the slurry stability is good, and the formed coating has good resistance to electrolyte swelling at high temperatures, as described in the above “Advantageous Effects of Invention”.

In the aqueous GPC measuring device, polymer-based packing materials such as polyhydroxymethacrylate commonly used as column packings can be used. For example, SB-806 HQ and SB-806M HQ of the Shodex OHpak series available from Showa Denko K.K. can be used as columns. Neutral salt solutions such as sodium nitrate solution, sodium hydrogen hydrochloride solution, sodium sulfate solution, and phosphate buffer solution can be used as eluents. Preferably, these eluents have a concentration of, for example, about 0.1 to 0.3 mol/L. For example, a Shimadzu/L20 system can be used as the GPC measuring device. Polystyrene or pullulan can be used as a standard in GPC measurement. Specifically, STANDARD P-82 (Pullulan) available from Showa Denko K.K. can be used as a standard.

As described above, the swelling rate of the dried polymer film of the negative electrode binder composition after immersion in a carbonate-based mixed solvent at 45° C. for 72 hours is 0 to 10% by weight. The swelling rate is preferably 0.1 to 6% by weight, more preferably 0.1 to 4% by weight. A lower swelling rate is preferable, and when the swelling rate is in the above range, the peel strength is stronger when a negative electrode is made. As a result, when battery evaluation is conducted, good charge-discharge characteristics can be exhibited even at high cycle counts.

The swelling rate can be obtained as follows. The negative electrode binder composition is dried at room temperature for 72 hours and at 150° C. for 30 minutes to make a dry polymer film (dry coating) with a film thickness of 150μ. The dry polymer film is then immersed in a carbonate-based mixed solvent (e.g., ethylene carbonate (EC)/diethylene carbonate (DEC)=50/50 (wt·r) at 60° C. for 72 hours. The weight of the film after immersion was measured, and the rate of change in weight before and after immersion is calculated as the swelling rate. A high swelling rate means that the negative electrode binder composition easily contains a solvent, and when a negative electrode is made, the mixture easily separates (peels) from a substrate such as copper.

### [Water-Soluble Resin (X)]

Examples of the hydroxyl group-containing monomer (a) in the copolymer include 2-hydroxyethyl acrylate, 2-hydroxypropyl acrylate, 3-hydroxypropyl acrylate, 2-hydroxybutyl acrylate, 4-hydroxybutyl acrylate, 2-hydroxyethyl methacrylate, 2-hydroxypropyl methacrylate, 3-hydroxypropyl methacrylate, 2-hydroxybutyl methacrylate, and 4-hydroxybutyl methacrylate. Among these, hydroxyethyl acrylate (especially 2-hydroxyethyl acrylate) is preferred as the hydroxyl group-containing monomer (a). The content of the hydroxyl group-containing monomer (a) relative to the total amount of monomers constituting the copolymer is, for example, 20 to 80% by weight, preferably 30 to 70% by weight. When the content of the hydroxyl group-containing monomer (a) is within the above range, both slurry stability and electrolyte swelling resistance at high temperatures of the formed coating tend to be good.

Examples of the acid group-containing monomer (b) in the copolymer include acrylic acid, methacrylic acid, maleic acid, monomethyl maleic acid, 2-carboxyethyl acrylate, 2-carboxyethyl methacrylate, maleic acid, and itaconic acid. Carboxylic acid is preferred as the acid group in the acid group-containing monomer (b). Among others, acrylic acid is particularly preferred as the acid group-containing monomer (b). The content of the acid group-containing monomer (b) relative to the total amount of monomers constituting the copolymer is, for example, 10 to 60% by weight, preferably 20 to 50% by weight. When the content of the acid group-containing monomer (b) is within the above range, both slurry stability and electrolyte swelling resistance at high temperatures of the formed coating tend to be good.

It is preferable that the acid group-containing monomer (b) in the copolymer is neutralized with a basic composition or a light metal salt. The content of the acid group-containing monomer (b) neutralized with a basic composition or a light metal salt is, for example, 10 to 60% by weight, preferably 20 to 50% by weight. When the content is within the above range, both slurry stability and electrolyte swelling resistance at high temperatures of the formed coating tend to be good.

The total content of resin components derived from the hydroxyl group-containing monomer (a) and the acid group-containing monomer (b) relative to the total amount of the water-soluble resin (X) is preferably 5 to 80% by weight, more preferably 10 to 70% by weight. When the total content is within the above range, both slurry stability and electrolyte swelling resistance at high temperatures of the formed coating tend to be good.

The copolymer that constitutes the water-soluble resin (X) may contain a monomer other than the hydroxyl group-containing monomer (a) and the acid group-containing monomer (b) (hereinafter referred to as “other monomer (c)”). Examples of other monomer (c) include acrylamide, methacrylamide, N-methylacrylamide, N,N-dimethylacrylamide, and N-hydroxymethylacrylamide. Among these, acrylamide is preferred as the other monomer (c), and the inclusion of acrylamide has the effect of increasing the toughness of the formed coating. When other monomer (c) is included, its content is, for example, 5 to 40% by weight, preferably 5 to 20% by weight. When the content of other monomer (c) is within the above range, the electrolyte swelling resistance at high temperature tends to be good.

The one or more selected from the group consisting of acrylamide, methacrylamide, N-methylacrylamide, N,N-dimethylacrylamide, and N-hydroxymethylacrylamide have a content of 0 to 80% by weight, preferably 2 to 60% by weight. When the content is within the above range, the electrolyte swelling resistance at high temperatures tends to be good.

The copolymer in the water-soluble resin (X) has a structural unit derived from each of the hydroxyl group-containing monomer (a) and the acid group-containing monomers (b), and other monomer (c) to be added as appropriate. The copolymer is obtained by appropriately preparing the hydroxyl group-containing monomer (a) and the acid group-containing monomer (b), and other monomer (c) to be added as necessary, as described below, and copolymerizing them in a known and customary manner.

### [Aqueous Latex Resin (Y)]

It is preferable that the aqueous latex resin (Y) includes one or more selected from a styrene-butadiene copolymer (SBR), a styrene acrylate copolymer, and an acrylate copolymer. Among these, the styrene acrylate copolymer is more preferred as the aqueous latex resin (Y). Examples of acrylate used in the styrene acrylate copolymer include methyl acrylate, methyl methacrylate, butyl acrylate, 2-ethylhexyl acrylate, acrylamide, acrylonitrile, and glycidyl methacrylate. Acrylic acid, methacrylic acid, or the like can also be used as necessary. Among these, butyl acrylate is preferred as the acrylate used in the styrene acrylate copolymer.

The percentage of the aqueous latex resin (Y) is preferably 20 to 80% by weight of the total negative electrode binder composition, more preferably 30 to 70% by weight. The styrene content in the styrene acrylate copolymer is 45 to 65% by weight, more preferably 50 to 60% by weight. The amount of butyl acrylate is preferably 20 to 40% by weight, more preferably 25 to 35% by weight. When the contents of styrene and butyl acrylate are within the above ranges, adhesion tends to be good.

### [Other Binder Components]

The negative electrode binder composition according to the present invention may contain conventionally used components other than those listed above (referred to as “other binder components”) as binder (binding agent) components to the extent that does not impair the effects of the present invention. Examples of other binder components include methacrylic copolymers composed of ethylenically unsaturated carboxylic acid esters (e.g., methyl (meth)acrylate, ethyl (meth)acrylate, butyl (meth)acrylate, (meth)acrylonitrile, hydroxyethyl (meth)acrylate, etc.) and ethylenically unsaturated carboxylic acid (e.g., acrylic acid, methacrylic acid, itaconic acid, fumaric acid, maleic acid, etc.); polymer compounds such as polyvinylidene fluoride, polyethylene oxide, polyepichlorohydrin, polyphosphazene, polyacrylonitrile, polyimide, polyamidoimide, and carboxymethyl cellulose (CMC). The negative electrode binder composition according to the present invention may contain an organic solvent such as N-methyl-2-pyrrolidone (NMP) in order to dissolve the above polymer compounds.

A negative electrode mixture slurry and a negative electrode according to the present invention contain the negative electrode binder composition above and components necessary for constructing the negative electrode, such as SiO negative electrode material, graphite, and acetylene black. Any kind of SiO negative electrode material and graphite can be used in the negative electrode mixture slurry and the negative electrode according to the present invention. The percentage (nonvolatile content) of the negative electrode binder composition in the negative electrode mixture slurry and the negative electrode according to the present invention is, for example, 2 to 10% by weight, preferably 3 to 5% by weight.

The SiO negative electrode material is a material containing SiO (silicon monoxide) as a main component that expresses charge-discharge characteristics in the negative electrode according to the present invention. In addition to the SiO negative electrode material, silicon particles, carbon, and the like that express charge-discharge characteristics similarly can be contained. Silicon oxycarbide (SiOC) may be contained as the SiO negative electrode material. Two or more of these components may be contained rather than being contained alone. The percentage of the SiO negative electrode material in the negative electrode mixture slurry and the negative electrode according to the present invention is, for example, 3 to 20% by weight, preferably 5 to 15% by weight.

The graphite can be natural graphite or artificial graphite artificially synthesized. Examples of the graphite include natural graphite, artificial graphite, hard carbon, soft carbon, and other carbon materials. The graphite is also a component that expresses charge-discharge characteristics in the same way as the SiO negative electrode material and the like. The percentage of the graphite in the negative electrode mixture slurry and the negative electrode according to the present invention is, for example, 80 to 97% by weight, preferably 85 to 95% by weight.

The acetylene black acts as a conductivity aid in the negative electrode according to the present invention and may be a component other than acetylene black, such as carbon black, Ketjenblack, or carbon nanotubes (CNT). The percentage of these components acting as conductivity aids in the negative electrode mixture slurry and the negative electrode according to the present invention is, for example, 0.05 to 10% by weight, preferably 0.1 to 5% by weight.

Any solvent can be used for the negative electrode mixture slurry according to the present invention as long as it can disperse the components necessary for constructing the negative electrode mixture slurry. An aqueous solvent can be used, and ion-exchanged water is preferred. The percentage of the solvent in the negative electrode mixture slurry is, for example, 30 to 70% by weight, preferably 40 to 60% by weight.

### [Method for Producing Negative Electrode Binder Composition]

An example of a method for producing the negative electrode binder composition according to the present invention will be described below. It is preferable that the method for producing the negative electrode binder composition according to the present invention includes steps of: kneading an aqueous slurry at least including an active material and the water-soluble resin (X); and thereafter reducing a solid content concentration and mixing the aqueous latex resin (Y).

First, the copolymer in the water-soluble resin (X), which is an essential component of the negative electrode binder composition, is synthesized. The copolymer is obtained by preparing a solvent such as water in a reaction vessel and heating the solvent to 50 to 80° C., and thereafter adding a mixture of the hydroxyl group-containing monomer (a) and the acid group-containing monomer (b), other monomer (c) as an optional component, and a polymerization initiator such as ammonium persulfate to allow a polymerization reaction to proceed. The polymerization reaction may be performed under an inert gas atmosphere such as nitrogen. The polymerization reaction can be performed at temperatures of 50 to 80° C. for 1 to 10 hours. After the reaction is completed, the reaction product is cooled and the pH is adjusted.

Next, an active material, other binder components, water, an organic solvent, and the like are added to the water-soluble resin (X) containing the resulting copolymer, and an aqueous slurry including these components is kneaded. The active material may be any of tin alloy, silicon alloy, silicon oxide, and the like. Examples of other binder components include polymer compounds such as ethylenically unsaturated carboxylic acid and ethylenically unsaturated carboxylic acid ester. N-methyl-2-pyrrolidone (NMP) is preferred as the organic solvent. Kneading may be performed by feeding a predetermined amount in one batch, or by feeding about half of the predetermined amount of each component for primary kneading and then feeding the entire predetermined amount for secondary kneading. A step of defoaming the aqueous slurry may be added as appropriate.

Then, after the aqueous slurry is kneaded, the solid content concentration of the slurry is reduced and the aqueous latex resin (Y) is mixed to obtain the negative electrode binder composition. The amount of the aqueous latex resin (Y) per 100 parts by weight of the water-soluble resin (X) is, for example, 50 to 300 parts by weight, preferably 80 to 200 parts by weight.

Furthermore, the negative electrode mixture slurry is obtained by adding components necessary for constructing the negative electrode, such as SiO negative electrode material, graphite, acetylene black, and solvent, to the negative electrode binder composition, and dispersing the resulting mixture in an aqueous solvent such as ion-exchanged water. The dispersion may be performed using a dispersing device such as stirrer, ball mill, super sand mill, or pressurized kneader. The negative electrode mixture slurry may also be prepared by mixing in a mixer.

### <Negative Electrode>

The negative electrode according to the present invention contains the above negative electrode binder composition as a component. In the negative electrode according to the present invention, the total content of a component derived from the water-soluble resin (X) and a component derived from the aqueous latex resin (Y) is preferably 1.5% by weight or more and 5.5% by weight or less, more preferably 2.0% by weight or more and 5.0% by weight or less. It is preferable that the negative electrode according to the present invention includes a graphite-based material as a main active material, and the negative electrode has a volume density of 1.4 g/cm³ or more. It is preferable to include a mixed active material of at least two or more of graphite-based materials and silicon-containing materials. Furthermore, it is preferable that the negative electrode according to the present invention has a mixture layer having a thickness of 80 μm or more.

The negative electrode according to the present invention is obtained by applying the negative electrode mixture slurry containing the negative electrode binder composition obtained above onto current collector copper foil to form a negative electrode layer as a thin film. The negative electrode may also be obtained by forming the negative electrode mixture slurry, which is the negative electrode binder composition, into the shape of sheet, pellet, or the like and integrating this with a current collector, as described below.

The material and the shape of the current collector are not limited. For example, copper, nickel, titanium, stainless steel, or the like formed into a strip in the shape of foil, perforated foil, mesh, or the like may be used. A porous material such as porous metal (foamed metal), carbon paper, or the like can also be used.

The method of application on the current collector copper foil is not limited. Examples of the method include known methods such as metal mask printing, electrostatic coating, dip coating, spray coating, roll coating, doctor blade process, gravure coating, and screen printing. After application, it is preferable to perform flat plate pressing or rolling with calender rolls or the like, if necessary.

The integration of the negative electrode mixture slurry formed into the shape of sheet, pellet, or the like with the current collector can be performed by known methods, such as rolling, pressing, or a combination of these methods. The electrode density after integration is, for example, 1.0 to 1.8 g/cm³, preferably 1.1 to 1.7 g/cm³.

It is preferable that the negative electrode layer formed on the current collector and the negative electrode layer integrated with the current collector are subjected to heat treatment. Heat treatment conditions are, for example, 5 to 20 hours at 80 to 150° C. This heat treatment can remove the solvent and cure the binder, resulting in higher strength, and can improve adhesion between particles and between particles and the current collector. It is preferable that the heat treatment is performed in an inert atmosphere such as helium, argon, or nitrogen, or a vacuum atmosphere in order to prevent oxidation of the current collector during the treatment.

### <Secondary Battery>

A secondary battery according to the present invention includes the negative electrode according to the present invention. For example, when used in a wet electrolyte secondary battery, the secondary battery according to the present invention can be constructed by disposing a positive electrode and the negative electrode according to the present invention to face each other with a separator interposed therebetween, and injecting an electrolyte.

The positive electrode can be obtained by forming a positive electrode layer on the surface of a current collector in the same manner as the negative electrode. In this case, the current collector can be a metal or an alloy such as aluminum, titanium, stainless steel formed into a strip in the shape of foil, perforated foil, mesh, or the like.

A positive electrode material to be used in the positive electrode layer is not limited. Among secondary batteries, when a lithium-ion secondary battery is fabricated, for example, metallic compounds, metal oxides, metal sulfides, or conductive polymer materials that can be doped or intercalated with lithium ions can be used and the positive electrode material is not limited. For example, lithium cobalt oxide (LiCoO₂), lithium nickel oxide (LiNiO₂), lithium manganese oxide (LiMnO₂), and composite oxide thereof (LiCoxNiyMnzO₂, x+y+z=1), lithium manganese spinel (LiMn₂O₄), lithium vanadium compound, V₂O₅, V₆O₁₃, VO₂, MnO₂, TiO₂, MoV₂O₈, TiS₂, V₂S₅, VS₂, MoS₂, MoS₃, Cr₃O₈, Cr₂O₅, olivine-type LiMPO₄ (M: Co, Ni, Mn, Fe), conductive polymers such as polyacetylene, polyaniline, polypyrrole, polythiophene, and polyacene, porous carbon, and the like can be used alone or in mixture.

As the separator, for example, a non-woven fabric, cloth, a microporous film, or a combination thereof, mainly made of polyolefin such as polyethylene or polypropylene can be used. When the positive electrode and the negative electrode of a nonaqueous electrolyte secondary battery to be fabricated are not in direct contact with each other, it is not necessary to use the separator.

As the electrolyte, for example, an organic electrolyte can be used in which a lithium salt such as LiClO₄, LiPF₆, LiAsF₆, LiBF₄, or LiSO₃CF₃ is dissolved in a non-aqueous solvent of a single component or a mixture of two or more components of ethylene carbonate, propylene carbonate, butylene carbonate, vinylene carbonate, fluoroethylene carbonate, cyclopentanone, sulfolane, 3-methylsulforane, 2,4-dimethylsulforane, 3-methyl-1,3-oxazolidin-2-one, γ-butyrolactone, dimethyl carbonate, diethyl carbonate, ethyl methyl carbonate, methyl propyl carbonate, butyl methyl carbonate, ethyl propyl carbonate, butyl ethyl carbonate, dipropyl carbonate, 1,2-dimethoxyethane, tetrahydrofuran, 2-methyltetrahydrofuran, 1,3-dioxolane, methyl acetate, ethyl acetate, and the like.

The structure of the secondary battery according to the present invention is not limited, but it is common to construct the secondary battery by winding a positive electrode and a negative electrode, and a separator, which is provided as necessary, into a flat spiral shape as a wound electrode group, or by stacking them as flat plates as a stacked electrode group, and by sealing each of these electrode groups in an outer casing.

The secondary battery according to the present invention can be used as, but not limited to, paper-type cell, button-type cell, coin-type cell, layered cell, cylindrical cell, prismatic cell, or the like. The negative electrode active material according to the present invention described above can also be applied to electrochemical devices in general that use insertion and desorption of lithium ions as a charge-discharge mechanism, such as hybrid capacitors and solid-state lithium secondary batteries.

### EXAMPLES

The present invention will be described in detail below with examples.

Synthesis Examples 1, 4, and 5 are methods for synthesizing the water-soluble resin (X) containing a copolymer of the hydroxyl group-containing monomer (a) and the acid group-containing monomer (b) as essential components. Synthesis Examples 6 to 15 are synthesis methods when the water-soluble resin (X) further contains other monomer (c). Synthesis Example 2 is a method for synthesizing a water-soluble resin (X) with a molecular weight of 700,000 or less as the water-soluble resin (X) for use in comparative examples. Synthesis Example 16 is a method for synthesizing a water-soluble resin (X) in which the acid group-containing monomer (b) is removed from the water-soluble resin (X) according to the present invention. Synthesis Example 17 is a method for synthesizing a water-soluble resin (X) in which the hydroxyl group-containing monomer (a) is removed from the water-soluble resin (X) according to the present invention. Synthesis Examples 18 to 20 are methods for synthesizing the aqueous latex resin (Y) made of a styrene acrylate copolymer, and Synthesis Example 21 is a method for synthesizing the aqueous latex resin (Y) made of an acrylate copolymer.

Negative electrode mixture slurry preparation example 1 is an example using the water-soluble resin (X) containing a copolymer of the hydroxyl group-containing monomer (a) and the acid group-containing monomer (b) as essential components according to the present invention (Synthesis Example 1), and SBR as the aqueous latex (Y). Negative electrode mixture slurry preparation examples 2 to 4 are examples using the water-soluble resin (X) containing a copolymer of the hydroxyl group-containing monomer (a) and the acid group-containing monomer (b) as essential components according to the present invention (Synthesis Examples 1, 4, and 5), and a styrene acrylate copolymer (Synthesis Example 18) as the aqueous latex (Y) Negative electrode mixture slurry preparation examples 5 to 13 are examples using the water-soluble resin (X) according to the present invention further containing other monomer (c) (Synthesis Examples 7 and 8 and 11 to 15), and a styrene acrylate copolymer (Synthesis Examples 18 to 20) as the aqueous latex (Y). Negative electrode mixture slurry preparation example 14 is an example using the water-soluble resin (X) according to the present invention further containing other monomer (c) (Synthesis Example 8) and an acrylate copolymer (Synthesis Example 21) as the aqueous latex (Y). Negative electrode mixture slurry preparation examples 15 and 16 are examples using the water-soluble resin (X) according to the present invention further containing other monomer (c) with the acid group-containing monomer (b) neutralized with a light metal hydroxide (Synthesis Example 9 (Li salt), Synthesis Example 10 (Na salt)), and a styrene acrylate copolymer (Synthesis Example 18) as the aqueous latex (Y). Negative electrode mixture slurry preparation examples 17 and 18 are examples using the water-soluble resin (X) according to the present invention further containing other monomer (c) (Synthesis Example 8) and a styrene acrylate copolymer (Synthesis Example 18) as the aqueous latex (Y), in which the amount of binder added is increased or decreased. Negative electrode mixture slurry preparation examples 19 and 20 are examples using the water-soluble resin (X) according to the present invention further containing other monomer (c) (Synthesis Example 8), and a styrene acrylate copolymer (Synthesis Example 18) as the aqueous latex (Y), and using a mixture of a graphite-based material and a silicon-containing material as an active material.

Negative electrode mixture slurry preparation example 21 is an example using CMC and SBR. Negative electrode mixture slurry preparation example 22 is an example only using the water-soluble resin (X) containing a copolymer of the hydroxyl group-containing monomer (a) and the acid group-containing monomer (b) as essential components (Synthesis Example 1). Negative electrode mixture slurry preparation example 23 is an example using CMC and a styrene acrylate copolymer (Synthesis Example 18) as the aqueous latex resin (Y). Negative electrode mixture slurry preparation example 24 is an example using the water-soluble resin (X) containing a copolymer of the hydroxyl group-containing monomer (a) and the acid group-containing monomer (b) as essential components with a molecular weight of less than 700000 (Synthesis Example 2), and a styrene acrylate copolymer (Synthesis Example 18) as the aqueous latex (Y). Negative electrode mixture slurry preparation example 25 is an example using the water-soluble resin (X) and a styrene acrylate copolymer (Synthesis Example 18) as the aqueous latex (Y), in which a swelling rate after immersing the dried polymer film in a carbonate-based mixed solvent at 45° C. for 72 hours is 10% or more. Negative electrode mixture slurry preparation example 26 is an example using the water-soluble resin (X) containing a copolymer of the unneutralized hydroxyl group-containing monomer (a) and the acid group-containing monomer (b) as essential components (Synthesis Example 6), and a styrene acrylate copolymer (Synthesis Example 18) as the aqueous latex (Y). Slurry preparation example 27 is an example using the water-soluble resin (X) in which the acid group-containing monomer (b) is removed from the water-soluble resin (X) according to the present invention (Synthesis Example 16), and a styrene acrylate copolymer (Synthesis Example 18) as the aqueous latex (Y). Slurry preparation example 28 is an example using the water-soluble resin (X) in which the hydroxyl group-containing monomer (a) is removed from the water-soluble resin (X) according to the present invention (Synthesis Example 17), and a styrene acrylate copolymer (Synthesis Example 18) as the aqueous latex (Y). Slurry preparation example 29 is an example using a commercially available sodium polyacrylate and a styrene acrylate copolymer (Synthesis Example 18) as the aqueous latex (Y). Negative electrode mixture slurry preparation examples 30 and 31 are examples using CMC and SBR, in which the amount of binder added is increased or decreased. Negative electrode mixture slurry preparation examples 32 and 33 are examples using CMC and SBR, and using a mixture of a graphite-based material and a silicon-containing material as an active material.

CMC (carboxymethyl cellulose sodium salt, SUNROSE MAC350 available from Nippon Paper Industries Co., Ltd.) and PAA-Na (sodium polyacrylate available from FUJIFILM Wako Pure Chemical Corporation, degree of polymerization 22000 to 70000) were used as the water-soluble resin (X) for comparative examples. A SBR (styrene-butadiene copolymer, LACSTAR DS407H available from DIC Corporation) was used as the aqueous latex resin (Y) for examples and comparative examples.

Positive electrode preparation examples 1 to 3 are methods for preparing positive electrodes used in the batteries of examples and comparative examples. Next, a method for preparing a negative electrode according to the present invention will be described with Examples 1 to 24, and a method for preparing a battery according to the present invention will be described with Examples 25 to 48. A method for preparing a negative electrode according to comparative examples will be described with Comparative Examples 1 to 17, and a method for preparing a battery according to comparative examples will be described with Comparative Examples 18 to 34.

### [Aqueous GPC Measurement]

In aqueous GPC measurement, a Shimadzu/L20 system was used as an HPLC system and Shodex OHpak SB-806MHQ (8.0 mm I.D.×300 mm L.×2 columns) was used as columns. The eluent was 0.2 mol/L sodium nitrate solution, and the sample was dissolved to 0.5% and filtered through a 0.45 pore diameter filter before measurement. The weight average molecular weight was determined using an RI detector while 50 μL of the sample was fed at a flow rate of 0.70 mL/min. The calibration curve was made using STANDARD P-82 (Pullulan) available from Showa Denko K.K. as a standard.

“Synthesis Examples of Water-Soluble Resin (X) Containing Copolymer of Hydroxyl Group-Containing Monomer (a) and Acid Group-Containing Monomer (b) as Essential Components”

### Synthesis Example 1

In a 1.0 L reaction vessel equipped with a stirrer, a thermometer and a cooler, and with a nitrogen blowing device, 500.0 parts by weight of ion-exchanged water was charged and heated to 75° C. after 3 hours of N₂ blow. To this, a mixture of 40.0 parts by weight of acrylic acid, 60.0 parts by weight of hydroxyethyl acrylate, 0.367 parts by weight of ammonium persulfate (1500 ppm relative to total moles of monomers), and 50.0 parts by weight of ion-exchanged water was fed dropwise for 3 hours to allow a polymerization reaction to proceed. After the feeding dropwise was completed, the same temperature was kept for 2 hours, followed by cooling. The pH was adjusted to a range of 6.8 to 7.2 and the nonvolatile content to a range of 14.8% by weight to 15.2% by weight by adding a 5 mol/L sodium hydroxide solution and distilled water at a temperature of 40° C. or lower. The resulting copolymer had a nonvolatile content of 14.8% by weight, a pH of 6.8, a viscosity of 3080 mPa·s, and a weight average molecular weight of 850,000 as measured by aqueous GPC.

### (Measurement of Degree of Swelling in Carbonate Mixture)

The resulting copolymer solution was applied on a PET film and thereafter left to dry at room temperature for 3 days to form a copolymer coating. This was peeled and cut into 1.0 cm×1.0 cm squares and dried in an air dryer at 80° C. for 1 hour and then in a vacuum dryer at 110° C. for 10 hours. The thickness of the resulting coating was from 100 to 150 μm. After the weight of the coating was measured, the coating was immersed in a carbonate-based mixed solvent (ethylene carbonate (EC)/diethylene carbonate (DEC)=50/50 (wt)) at 45° C. for 72 hours, and the weight of the coating was measured again. The degree of swelling in the carbonate mixed solvent calculated according to the following formula (1) was 5.3%.

{(weight of coating after immersion−weight of coating before immersion)/(weight of coating before immersion)}×100 formula (1)

### Synthesis Example 2

A polymerization reaction was performed completely in the same manner as in Synthesis Example 1, except that N₂ blow for 3 hours was not performed. The resulting copolymer had a nonvolatile content of 15.0% by weight, a pH of 6.8, a viscosity of 1380 mPa·s, and a weight average molecular weight of 480,000 as measured by aqueous GPC. The degree of swelling in the carbonate mixed solvent was 5.3%.

### Synthesis Example 3

A polymerization reaction was performed completely in the same manner as in Synthesis Example 1 except that 20.0 parts by weight of acrylic acid, 80.0 parts by weight of hydroxyethyl acrylate, and 0.340 parts by weight of ammonium persulfate (1500 ppm relative to total moles of monomers) were used. The resulting copolymer had a nonvolatile content of 14.9% by weight, a pH of 7.0, a viscosity of 2800 mPa·s, and a weight average molecular weight of 750,000 as measured by aqueous GPC. The degree of swelling in the carbonate mixed solvent was 26.9%.

### Synthesis Example 4

A polymerization reaction was performed completely in the same manner as in Synthesis Example 1 except that 60.0 parts by weight of 4-hydroxybutyl acrylate was used instead of 60.0 parts by weight of hydroxyethyl acrylate, and 0.332 parts by weight of ammonium persulfate (1500 ppm relative to total moles of monomers) was used. The resulting copolymer had a nonvolatile content of 15.1% by weight, a pH of 6.9, a viscosity of 3000 mPa·s, and a weight average molecular weight of 800,000 as measured by aqueous GPC. The degree of swelling in the carbonate mixed solvent was 6.2%.

### Synthesis Example 5

A polymerization reaction was performed completely in the same manner as in Synthesis Example 1 except that 40.0 parts by weight of 2-carboxyethyl acrylate was used instead of 40.0 parts by weight of acrylic acid, and 0.272 parts by weight of ammonium persulfate (1500 ppm relative to total moles of monomers) was used. The resulting copolymer had a nonvolatile content of 14.9% by weight, a pH of 6.9, a viscosity of 3000 mPa·s, and a weight average molecular weight of 840,000 as measured by aqueous GPC. The degree of swelling in the carbonate mixed solvent was 5.5%.

### Synthesis Example 6

A polymerization reaction was performed completely in the same manner as in Synthesis Example 1, except that the pH adjustment by adding a 5 mol/L sodium hydroxide solution was not performed. The resulting product had a nonvolatile content of 15.0% by weight, a pH of 3.8, a viscosity of 2050 mPa·s, and a weight average molecular weight of 830,000 as measured by aqueous GPC. The degree of swelling in the carbonate mixed solvent was 5.8%.

### Synthesis Example 7

In a 1.0 L reaction vessel equipped with a stirrer, a thermometer and a cooler, and with nitrogen blow, 500.0 parts by weight of ion-exchanged water was charged and heated to 75° C. after 3 hours of N₂ blow. To this, a mixture of 30.0 parts by weight of acrylic acid, 60.0 parts by weight of hydroxyethyl acrylate, 10.0 parts by weight of acrylamide, 0.443 parts by weight of ammonium persulfate (1500 ppm relative to total moles of monomers), and 50.0 parts by weight of ion-exchanged water was fed dropwise for 3 hours to allow a polymerization reaction to proceed. After the feeding dropwise was completed, the same temperature was kept for 2 hours, followed by cooling. The pH was adjusted to a range of 6.8 to 7.2 and the nonvolatile content to a range of 14.8% by weight to 15.2% by weight by adding a 5 mol/L sodium hydroxide solution and distilled water at a temperature of 40° C. or lower. The resulting copolymer had a nonvolatile content of 15.0% by weight, a pH of 7.1, a viscosity of 3100 mPa·s, and a weight average molecular weight of 730,000 as measured by aqueous GPC. The degree of swelling in the carbonate mixed solvent was 4.2%.

### Synthesis Example 8

A polymerization reaction was performed completely in the same manner as in Synthesis Example 7 except that 20.0 parts by weight of acrylic acid, 20.0 parts by weight of hydroxyethyl acrylate, 60.0 parts by weight of acrylamide, 0.405 parts by weight of ammonium persulfate (1500 ppm relative to total moles of monomers), and 25% ammonia water instead of a 5 mol/L sodium hydroxide solution were used. The resulting copolymer had a nonvolatile content of 15.0% by weight, a pH of 7.0, a viscosity of 12500 mPa·s, and a weight average molecular weight of 780,000 as measured by aqueous GPC. The degree of swelling in the carbonate mixed solvent was 4.5%.

### Synthesis Example 9

A polymerization reaction was performed completely in the same manner as in Synthesis Example 7 except that 20.0 parts by weight of acrylic acid, 20.0 parts by weight of hydroxyethyl acrylate, 60.0 parts by weight of acrylamide, and 0.405 parts by weight of ammonium persulfate (1500 ppm relative to total moles of monomers) were used. The resulting copolymer had a nonvolatile content of 15.0% by weight, a pH of 7.0, a viscosity of 13700 mPa·s, and a weight average molecular weight of 780,000 as measured by aqueous GPC. The degree of swelling in the carbonate mixed solvent was 6.0%.

### Synthesis Example 10

A polymerization reaction was performed completely in the same manner as in Synthesis Example 7 except that 20.0 parts by weight of acrylic acid, 20.0 parts by weight of hydroxyethyl acrylate, 60.0 parts by weight of acrylamide, 0.405 parts by weight of ammonium persulfate (1500 ppm relative to total moles of monomers), and a 5 mol/L lithium hydroxide solution instead of a 5 mol/L sodium hydroxide solution were used. The resulting copolymer had a nonvolatile content of 15.0% by weight, a pH of 7.0, a viscosity of 13200 mPa·s, and a weight average molecular weight of 780,000 as measured by aqueous GPC. The degree of swelling in the carbonate mixed solvent was 5.3%.

### Synthesis Example 11

A polymerization reaction was performed completely in the same manner as in Synthesis Example 7 except that 20.0 parts by weight of acrylic acid, 20.0 parts by weight of hydroxyethyl acrylate, hydroxymethylacrylamide instead of 60.0 parts by weight of acrylamide, 0.357 parts by weight of ammonium persulfate (1500 ppm relative to total moles of monomers), and 25% ammonia water instead of a 5 mol/L sodium hydroxide solution were used. The resulting copolymer had a nonvolatile content of 15.0% by weight, a pH of 7.0, a viscosity of 17100 mPa·s, and a weight average molecular weight of 830,000 as measured by aqueous GPC. The degree of swelling in the carbonate mixed solvent was 4.6%.

### Synthesis Example 12

A polymerization reaction was performed completely in the same manner as in Synthesis Example 7 except that 10.0 parts by weight of acrylic acid, 10.0 parts by weight of hydroxyethyl acrylate, 80.0 parts by weight of acrylamide, 0.438 parts by weight of ammonium persulfate (1500 ppm relative to total moles of monomers), and 25% ammonia water instead of a 5 mol/L sodium hydroxide solution were used. The resulting copolymer had a nonvolatile content of 14.9% by weight, a pH of 7.0, a viscosity of 15200 mPa·s, and a weight average molecular weight of 860,000 as measured by aqueous GPC. The degree of swelling in the carbonate mixed solvent was 6.2%.

### Synthesis Example 13

A polymerization reaction was performed completely in the same manner as in Synthesis Example 7 except that 35.0 parts by weight of acrylic acid, 35.0 parts by weight of hydroxyethyl acrylate, 30.0 parts by weight of acrylamide, 0.414 parts by weight of ammonium persulfate (1500 ppm relative to total moles of monomers), and 25% ammonia water instead of a 5 mol/L sodium hydroxide solution were used. The resulting copolymer had a nonvolatile content of 15.0% by weight, a pH of 7.0, a viscosity of 13300 mPa·s, and a weight average molecular weight of 840,000 as measured by aqueous GPC. The degree of swelling in the carbonate mixed solvent was 6.0%.

### Synthesis Example 14

A polymerization reaction was performed completely in the same manner as in Synthesis Example 7 except that 20.0 parts by weight of acrylic acid, 40.0 parts by weight of hydroxyethyl acrylate, 40.0 parts by weight of acrylamide, 0.442 parts by weight of ammonium persulfate (1500 ppm relative to total moles of monomers), and 25% ammonia water instead of a 5 mol/L sodium hydroxide solution were used. After the feeding dropwise was completed, the same temperature was kept for 2 hours, followed by cooling. The pH was adjusted by adding ammonia solution at a temperature of 40° C. or lower. The resulting copolymer had a nonvolatile content of 15.1% by weight, a pH of 7.0, a viscosity of 14500 mPa·s, and a weight average molecular weight of 830,000 as measured by aqueous GPC. The degree of swelling in the carbonate mixed solvent was 5.8%.

### Synthesis Example 15

A polymerization reaction was performed completely in the same manner as in Synthesis Example 7 except that 30.0 parts by weight of acrylic acid, 20.0 parts by weight of hydroxyethyl acrylate, 50.0 parts by weight of acrylamide, 0.424 parts by weight of ammonium persulfate (1500 ppm relative to total moles of monomers), and 25% ammonia water instead of a 5 mol/L sodium hydroxide solution were used. After the feeding dropwise was completed, the same temperature was kept for 2 hours, followed by cooling. The pH was adjusted by adding ammonia solution at a temperature of 40° C. or lower. The resulting copolymer had a nonvolatile content of 15.1% by weight, a pH of 7.0, a viscosity of 13,000 mPa·s, and a weight average molecular weight of 840,000 as measured by aqueous GPC. The degree of swelling in the carbonate mixed solvent was 5.3%.

### Synthesis Example 16

In a 1.0 L reaction vessel equipped with a stirrer, a thermometer and a cooler, and with nitrogen blow, 500.0 parts by weight of ion-exchanged water was charged and heated to 75° C. after 3 hours of N₂ blow. To this, a mixture of 70.0 parts by weight of hydroxyethyl acrylate, 30.0 parts by weight of acrylamide, 0.351 parts by weight of ammonium persulfate (1500 ppm relative to total moles of monomers), and 50.0 parts by weight of ion-exchanged water was fed dropwise for 3 hours to allow a polymerization reaction to proceed. After the feeding dropwise was completed, the same temperature was kept for 2 hours, followed by cooling. The resulting copolymer had a nonvolatile content of 15.0% by weight, a pH of 7.0, a viscosity of 4300 mPa·s, and a weight average molecular weight of 750,000 as measured by aqueous GPC. The degree of swelling in the carbonate mixed solvent was 17.5%.

### Synthesis Example 17

In a 1.0 L reaction vessel equipped with a stirrer, a thermometer and a cooler, and with nitrogen blow, 500.0 parts by weight of ion-exchanged water was charged and heated to 75° C. after 3 hours of N2 blow. To this, a mixture of 70.0 parts by weight of hydroxyethyl acrylate, 30.0 parts by weight of acrylamide, 0.351 parts by weight of ammonium persulfate (1500 ppm relative to total moles of monomers), and 50.0 parts by weight of ion-exchanged water was fed dropwise for 3 hours to allow a polymerization reaction to proceed. After the feeding dropwise was completed, the same temperature was kept for 2 hours, followed by cooling. The pH was adjusted to a range of 6.8 to 7.2 and the nonvolatile content to a range of 14.8% by weight to 15.2% by weight by adding a 5 mol/L sodium hydroxide solution and distilled water at a temperature of 40° C. or lower. The resulting copolymer had a nonvolatile content of 15.0% by weight, a pH of 7.0, a viscosity of 8900 mPa·s, and a weight average molecular weight of 820,000 as measured by aqueous GPC. The degree of swelling in the carbonate mixed solvent was 5.1%.

The monomer composition (% by weight), the presence or absence of N₂ blow, the base used for neutralization, the nonvolatile content, the pH, the viscosity, the weight average molecular weight of polymer, and the degree of swelling in the carbonate mixed solvent in “Synthesis Examples of Water-Soluble Resin (X) Containing Copolymer of Hydroxyl Group-Containing Monomer (a) and Acid Group-Containing Monomer (b) as Essential Components” in the above Synthesis Examples 1 to 17 are listed in Table 1 below.

### Synthesis Examples of Water-Soluble Resin (X) Containing Copolymer of Hydroxyl Group-Containing Monomer (a) and Acid Group-Containing Monomer (b) as Essential Components

TABLE 1

| | Synthesis | Synthesis | Synthesis | Synthesis | Synthesis | Synthesis | Synthesis | Synthesis | Synthesis | Synthesis |
|---|---|---|---|---|---|---|---|---|---|---|
| Resin name | Ex. 1 | Ex. 2 | Ex. 3 | Ex. 4 | Ex. 5 | Ex. 6 | Ex. 7 | Ex. 8 | Ex. 9 | Ex. 10 |
| Hydroxyethyl | 60 | 50 | 75 | | 60 | 60 | 60 | 20 | 20 | 20 |
| acrylate | | | | | | | | | | |
| (HEA) (a) | | | | | | | | | | |
| 4- | | | | 60 | | | | | | |
| Hydroxybutyl | | | | | | | | | | |
| acrylate | | | | | | | | | | |
| (HBA) (a′) | | | | | | | | | | |
| Acrylic acid | 40 | 40 | 25 | 40 | | 40 | 30 | 20 | 20 | 20 |
| (AA) (b) | | | | | | | | | | |
| 2- | | | | | 40 | | | | | |
| Carboxyethyl | | | | | | | | | | |
| acrylate | | | | | | | | | | |
| (CEA) (b′) | | | | | | | | | | |
| Acrylamide | | 0 | 0 | | | 0 | 10 | 60 | 60 | 60 |
| (AAM) (c) | | | | | | | | | | |
| Hydroxymethyl | | | | | | | | | | |
| acrylamide | | | | | | | | | | |
| (HAAM) (c′) | | | | | | | | | | |
| N₂ blow (3 | Present | Absent | Present | Present | Present | Present | Present | Present | Present | Present |
| hours) | | | | | | | | | | |
| Base used for | NaOH | NaOH | NaOH | NaOH | NaOH | — | NaOH | NH₃ | LiOH | NaOH |
| neutralization | | | | | | | | | | |
| Nonvolatile | 14.8 | 15 | 14.9 | 15.1 | 14.9 | 15 | 15.1 | 15 | 15 | 15 |
| content (%) | | | | | | | | | | |
| pH | 6.80 | 6.8 | 7 | 6.9 | 6.9 | 3.8 | 7.1 | 7 | 7 | 7 |
| Viscosity | 3080 | 1380 | 2800 | 3000 | 2900 | 2050 | 3100 | 12500 | 13700 | 13200 |
| (mPa · s) | | | | | | | | | | |
| Weight | 850000 | 480000 | 750000 | 800000 | 840000 | 830000 | 730000 | 780000 | 780000 | 780000 |
| average | | | | | | | | | | |
| molecular | | | | | | | | | | |
| weight | | | | | | | | | | |
| Electrolyte | 5.3 | 5.3 | 5.7 | 6.2 | 5.5 | 5.8 | 4.2 | 4.5 | 5.3 | 5.3 |
| swelling (%) | | | | | | | | | | |

| | Synthesis | Synthesis | Synthesis | Synthesis | Synthesis | Synthesis | Synthesis |
|---|---|---|---|---|---|---|---|
| Resin name | Ex. 11 | Ex. 12 | Ex. 13 | Ex. 14 | Ex. 15 | Ex. 16 | Ex. 17 |
| Hydroxyethyl | 20 | 10 | 35 | 20 | 30 | 70 | 0 |
| acrylate | | | | | | | |
| (HEA) (a) | | | | | | | |
| 4- | | | | | | | |
| Hydroxybutyl | | | | | | | |
| acrylate | | | | | | | |
| (HBA) (a′) | | | | | | | |
| Acrylic acid | 20 | 10 | 35 | 40 | 20 | 0 | 70 |
| (AA) (b) | | | | | | | |
| 2- | | | | | | | |
| Carboxyethyl | | | | | | | |
| acrylate | | | | | | | |
| (CEA) (b′) | | | | | | | |
| Acrylamide | | 80 | 30 | 40 | 50 | 30 | 30 |
| (AAM) (c) | | | | | | | |
| Hydroxymethyl | 60 | | | | | | |
| acrylamide | | | | | | | |
| (HAAM) (c′) | | | | | | | |
| N₂ blow (3 | Present | Present | Present | Present | Present | Present | Present |
| hours) | | | | | | | |
| Base used for | NH₃ | NH₃ | NH₃ | NH₃ | NH₃ | — | NaOH |
| neutralization | | | | | | | |
| Nonvolatile | 15 | 15 | 15 | 15 | 15 | 15 | 15 |
| content (%) | | | | | | | |
| pH | 7 | 7 | 7 | 7 | 7 | 7 | 7 |
| Viscosity | 17100 | 15200 | 13300 | 14500 | 13000 | 4300 | 8900 |
| (mPa · s) | | | | | | | |
| Weight | 830000 | 860000 | 840000 | 830000 | 840000 | 750000 | 820000 |
| average | | | | | | | |
| molecular | | | | | | | |
| weight | | | | | | | |
| Electrolyte | 4.6 | 6.2 | 6 | 5.8 | 5.3 | 17.5 | 5.1 |
| swelling (%) | | | | | | | |

### “Synthesis Examples of Aqueous Latex Resin (Y)”

### Synthesis Example 18

In a 2 L reaction vessel equipped with a stirrer, a thermometer, a cooler, and a nitrogen blowing device, 450 parts by mass of ion-exchanged water was charged and heated to 80° C. after 3 hours of N₂ blow. To this, an emulsion obtained by emulsifying 272.5 parts by mass of styrene, 150 parts by mass of n-butyl acrylate, 40 parts by mass of hydroxyethyl methacrylate, 25 parts by mass of methacrylic acid, 10 parts by mass of acrylamide, 2.5 parts by weight of glycidyl methacrylate, 10 parts by mass of sodium dodecylbenzene sulfonate, 1.25 parts by mass of ammonium persulfate, and 120 parts by mass of ion-exchanged water in a homogenizer was added dropwise for 3 hours to allow emulsion polymerization to proceed. After stirring at 80° C. for 2 hours, the emulsion was cooled to 40° C. or lower. The pH was adjusted to 6 to 7 with ammonia water and the nonvolatile content was adjusted to 39 to 41% with ion-exchanged water. The resulting aqueous latex resin had a nonvolatile content of 39.6%, a viscosity of 28 mPa·s, and a pH of 6.9.

### Synthesis Example 19

A polymerization reaction was performed completely in the same manner as in Synthesis Example 18, except that 172.5 parts by weight of styrene and 250 parts by mass of n-butyl acrylate were used. The emulsion was cooled to 40° C. or lower, the pH was adjusted to 6 to 7 with ammonia water, and the nonvolatile content was adjusted to 39 to 41% with ion-exchanged water. The resulting polymer emulsion had a nonvolatile content of 40.5%, a viscosity of 31 mPa·s, and a pH of 7.0.

### Synthesis Example 20

A polymerization reaction was performed completely in the same manner as in Synthesis Example 18 except that 222.5 parts by weight of styrene and 220 parts by mass of n-butyl acrylate were used. The emulsion was cooled to 40° C. or lower, the pH was adjusted to 6 to 7 with ammonia water, and the nonvolatile content was adjusted to 39 to 41% with ion-exchanged water. The resulting polymer emulsion had a nonvolatile content of 40.0%, a viscosity of 27 mPa·s, and a pH of 7.0.

### Synthesis Example 21

A polymerization reaction was performed completely in the same manner as in Synthesis Example 18 except that 272.5 parts by weight of benzyl acrylate was used instead of styrene. The emulsion was cooled to 40° C. or lower, the pH was adjusted to 6 to 7 with ammonia water, and the nonvolatile content was adjusted to 39 to 41% with ion-exchanged water. The resulting polymer emulsion had a nonvolatile content of 40.0%, a viscosity of 34 mPa·s, and a pH of 7.0.

The monomer composition (% by weight), the base used for neutralization, the pH, the weight average molecular weight of polymer, the nonvolatile content, and the viscosity in “Synthesis Examples of Aqueous Latex Resin (Y)” in Synthesis Examples 18 to 21 are listed in Table 2 below.

### Synthesis Examples of Aqueous Latex Resin (Y)

TABLE 2

| | Synthesis | Synthesis | Synthesis | Synthesis |
|---|---|---|---|---|
| | Ex. | Ex. | Ex. | Ex. |
| Resin name | 18 | 19 | 20 | 21 |
| Hydroxyethyl | 8 | 8 | 8 | 8 |
| methacrylate (HEMA) | | | | |
| Acrylamide (AAM) | 2 | 2 | 2 | 2 |
| Methacrylic acid (MAA) | 5 | 5 | 5 | 5 |
| Styrene (ST) | 54.5 | 34.5 | 44.5 | 0 |
| Benzyl acrylate (BNA) | 0 | 0 | 0 | 54.5 |
| Butyl acrylate (BA) | 30 | 50 | 40 | 30 |
| Glycidyl | 0.5 | 0.5 | 0.5 | 0.5 |
| methacrylate (GMA) | | | | |
| Base used for | NH₃ | NH₃ | NH₃ | NH₃ |
| neutralization | | | | |
| Nonvolatile content (%) | 40.2 | 40.5 | 40 | 40 |
| pH | 7 | 7 | 7 | 7 |
| Viscosity (mPa · s) | 30 | 31 | 27 | 34 |

### “Negative Electrode Mixture Slurry Preparation Examples”

### Slurry Preparation Example 1

In a planetary centrifugal mixer (ARE-310 available from Thinky Corporation), 96.0 parts by weight of artificial graphite (initial charge capacity 390 mAh/g, initial discharge capacity 350 mAh/g) and 1.0 part by weight of acetylene black were stirred for 30 seconds at 1000 rpm for rotation and 2000 rpm for revolution. The binder composition listed in Synthesis Example 1 above (HEA/AA=60/40, Na salt, weight average molecular weight 850000, nonvolatile content concentration 14.8%) was diluted with distilled water to adjust the nonvolatile content concentration to 4.0%, and 27.0 parts by weight (1.08 parts by weight in terms of solid content) of the diluted aqueous solution was mixed with 25.0 parts by weight of distilled water until the entire mixture became a paste. Subsequently, the mixture was stirred for 2 minutes in a planetary centrifugal mixer (ARE-310 available from Thinky Corporation) at 1000 rpm for rotation and 2000 rpm for revolution, and the mixture, which was heated by the stirring, was cooled to room temperature in ice water. The mixture was stirred again at 1000 rpm for rotation and 2000 rpm for revolution for 2 minutes, and then cooled to room temperature in ice water. The aqueous solution of the binder composition listed in Synthesis Example 1 above adjusted in advance to a nonvolatile content concentration of 4% was added in the amount of 10.5 parts by weight (0.42 parts by weight in terms of nonvolatile content) and mixed until the entire mixture was homogeneous. Subsequently, the mixture was stirred for 2 minutes in a planetary centrifugal mixer (ARE-310 available from Thinky Corporation) at 1000 rpm for rotation and 2000 rpm for revolution and cooled to room temperature in ice water. With the addition of 7 parts by weight of distilled water and 2.95 parts by weight of a styrene-butadiene copolymer (SBR) (DS407H available from DIC Corporation, nonvolatile content concentration 50.8%), the mixture was stirred again for 30 seconds in a planetary centrifugal mixer (ARE-310 available from Thinky Corporation) at 1000 rpm for rotation and 2000 rpm for revolution to prepare a negative electrode mixture slurry.

### Slurry Preparation Example 2

A negative electrode mixture slurry was prepared completely in the same manner as in Slurry Preparation Example 1, except that 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%) was used instead of SBR.

### Slurry Preparation Example 3

A negative electrode mixture slurry was prepared completely in the same manner as in Slurry Preparation Example 1, except that the binder composition synthesized in Synthesis Example 4 (HBA/AA=60/40, Na salt, weight average molecular weight 800000, nonvolatile content concentration 15.1%) was used instead of Synthesis Example 1 and 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%) was used instead of SBR.

### Slurry Preparation Example 4

A negative electrode mixture slurry was prepared completely in the same manner as in Slurry Preparation Example 1, except that the binder composition synthesized in Synthesis Example 5 (HBA/CEA=60/40, Na salt, weight average molecular weight 840000, nonvolatile content concentration 14.9%) was used instead of Synthesis Example 1 and 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%) was used instead of SBR.

### Slurry Preparation Example 5

A negative electrode mixture slurry was prepared completely in the same manner as in Slurry Preparation Example 1, except that the binder composition synthesized in Synthesis Example 7 (HEA/AA/AAM=60/30/10, Na salt, weight average molecular weight 730000, nonvolatile content concentration 15.1%) was used instead of Synthesis Example 1 and 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%) was used instead of SBR.

### Slurry Preparation Example 6

A negative electrode mixture slurry was prepared completely in the same manner as in Slurry Preparation Example 1, except that the binder composition synthesized in Synthesis Example 8 (HEA/AA/AAM=20/20/60, ammonium salt, weight average molecular weight 780000, nonvolatile content concentration 15.0%) was used instead of Synthesis Example 1 and 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%) was used instead of SBR.

### Slurry Preparation Example 7

A negative electrode mixture slurry was prepared completely in the same manner as in Slurry Preparation Example 1, except that the binder composition synthesized in Synthesis Example 11 (HEA/AA/HAAM=20/20/60, ammonium salt, weight average molecular weight 830000, nonvolatile content concentration 15.0%) was used instead of Synthesis Example 1 and 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%) was used instead of SBR.

### Slurry Preparation Example 8

A negative electrode mixture slurry was prepared completely in the same manner as in Slurry Preparation Example 1, except that the binder composition synthesized in Synthesis Example 12 (HEA/AA/AAM=10/10/80, ammonium salt, weight average molecular weight 860000, nonvolatile content concentration 14.9%) was used instead of Synthesis Example 1 and 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%) was used instead of SBR.

### Slurry Preparation Example 9

A negative electrode mixture slurry was prepared completely in the same manner as in Slurry Preparation Example 1, except that the binder composition synthesized in Synthesis Example 13 (HEA/AA/AAM=35/35/30, ammonium salt, weight average molecular weight 840000, nonvolatile content concentration 15.0%) was used instead of Synthesis Example 1 and 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%) was used instead of SBR.

### Slurry Preparation Example 10

A negative electrode mixture slurry was prepared completely in the same manner as in Slurry Preparation Example 1, except that the binder composition synthesized in Synthesis Example 14 (HEA/AA/AAM=20/40/40, ammonium salt, weight average molecular weight 830000, nonvolatile content concentration 15.1%) was used instead of Synthesis Example 1 and 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%) was used instead of SBR.

### Slurry Preparation Example 11

A negative electrode mixture slurry was prepared completely in the same manner as in Slurry Preparation Example 1, except that the binder composition synthesized in Synthesis Example 15 (HEA/AA/AAM=30/20/50, ammonium salt, weight average molecular weight 840000, nonvolatile content concentration 15.1%) was used instead of Synthesis Example 1 and 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%) was used instead of SBR.

### Slurry Preparation Example 12

A negative electrode mixture slurry was prepared completely in the same manner as in Slurry Preparation Example 1, except that the binder composition synthesized in Synthesis Example 8 (HEA/AA/AAM=20/20/60, ammonium salt, weight average molecular weight 780000, nonvolatile content concentration 15.0%) was used instead of Synthesis Example 1 and 3.73 parts by weight of the aqueous latex resin (Y) synthesized in Synthesis Example 19 (ST/BA/HEMA/MMA/AAM/GMA=54.5/30/8/5/2/0.5, nonvolatile content concentration 40.2%) was used instead of SBR.

### Slurry Preparation Example 13

A negative electrode mixture slurry was prepared completely in the same manner as in Slurry Preparation Example 1, except that the binder composition synthesized in Synthesis Example 8 (HEA/AA/AAM=20/20/60, ammonium salt, weight average molecular weight 780000, nonvolatile content concentration 15.0%) was used instead of Synthesis Example 1 and 3.70 parts by weight of the aqueous latex resin (Y) synthesized in Synthesis Example 19 (ST/BA/HEMA/MMA/AAM/GMA=34.5/50/8/5/2/0.5, nonvolatile content concentration 40.5%) was used instead of SBR.

### Slurry Preparation Example 14

A negative electrode mixture slurry was prepared completely in the same manner as in Slurry Preparation Example 1, except that the binder composition synthesized in Synthesis Example 8 (HEA/AA/AAM=20/20/60, ammonium salt, weight average molecular weight 780000, nonvolatile content concentration 15.0%) was used instead of Synthesis Example 1 and 3.75 parts by weight of the aqueous latex resin (Y) synthesized in Synthesis Example 20 (BNA/BA/HEMA/MMA/AAM/GMA=34.5/50/8/5/2/0.5, nonvolatile content concentration 40.0%) was used instead of SBR.

### Slurry Preparation Example 15

A negative electrode mixture slurry was prepared completely in the same manner as in Slurry Preparation Example 1, except that the binder composition synthesized in Synthesis Example 9 (HEA/AA/AAM=20/20/60, Li salt, weight average molecular weight 780000, nonvolatile content concentration 15.0%) was used instead of Synthesis Example 1 and 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%) was used instead of SBR.

### Slurry Preparation Example 16

A negative electrode mixture slurry was prepared completely in the same manner as in Slurry Preparation Example 1, except that the binder composition synthesized in Synthesis Example 10 (HEA/AA/AAM=20/20/60, Na salt, weight average molecular weight 780000, nonvolatile content concentration 15.0%) was used instead of Synthesis Example 1 and 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%) was used instead of SBR.

### Slurry Preparation Example 17

In a planetary centrifugal mixer (ARE-310 available from Thinky Corporation), 95.0 parts by weight of artificial graphite (initial charge capacity 390 mAh/g, initial discharge capacity 350 mAh/g) and 1.0 part by weight of acetylene black were stirred for 30 seconds at 1000 rpm for rotation and 2000 rpm for revolution. The binder composition synthesized in Synthesis Example 8 above (HEA/AA/AAM=20/20/60, ammonium salt, weight average molecular weight 780000, nonvolatile content concentration 15.0%) was diluted with distilled water to adjust the nonvolatile content concentration to 4.0%, and 39.5 parts by weight (1.58 parts by weight in terms of solid content) of the diluted aqueous solution was mixed with 12.5 parts by weight of distilled water until the entire mixture became a paste. Subsequently, the mixture was stirred for 2 minutes in a planetary centrifugal mixer (ARE-310 available from Thinky Corporation) at 1000 rpm for rotation and 2000 rpm for revolution, and the mixture, which was heated by the stirring, was cooled to room temperature in ice water. The mixture was stirred again at 1000 rpm for rotation and 2000 rpm for revolution for 2 minutes, and then cooled to room temperature in ice water. The aqueous solution of the binder composition listed in Synthesis Example 8 above adjusted in advance to a nonvolatile content concentration of 4% was added in the amount of 10.5 parts by weight (0.42 parts by weight in terms of nonvolatile content) and mixed until the entire mixture was homogeneous. Subsequently, the mixture was stirred for 2 minutes in a planetary centrifugal mixer (ARE-310 available from Thinky Corporation) at 1000 rpm for rotation and 2000 rpm for revolution and cooled to room temperature in ice water. With the addition of 6 parts by weight of distilled water and 4.98 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%), the mixture was stirred again for 30 seconds in a planetary centrifugal mixer (ARE-310 available from Thinky Corporation) at 1000 rpm for rotation and 2000 rpm for revolution to prepare a negative electrode mixture slurry.

### Slurry Preparation Example 18

In a planetary centrifugal mixer (ARE-310 available from Thinky Corporation), 96.0 parts by weight of artificial graphite (initial charge capacity 390 mAh/g, initial discharge capacity 350 mAh/g) and 1.0 part by weight of acetylene black were stirred for 30 seconds at 1000 rpm for rotation and 2000 rpm for revolution. The binder composition synthesized in Synthesis Example 8 above (HEA/AA/AAM=20/20/60, ammonium salt, weight average molecular weight 780000, nonvolatile content concentration 15.0%) was diluted with distilled water to adjust the nonvolatile content concentration to 4.0%, and 19.5 parts by weight (0.78 parts by weight in terms of solid content) of the diluted aqueous solution was mixed with 32.5 parts by weight of distilled water until the entire mixture became a paste. Subsequently, the mixture was stirred for 2 minutes in a planetary centrifugal mixer (ARE-310 available from Thinky Corporation) at 1000 rpm for rotation and 2000 rpm for revolution, and the mixture, which was heated by the stirring, was cooled to room temperature in ice water. The mixture was stirred again at 1000 rpm for rotation and 2000 rpm for revolution for 2 minutes, and then cooled to room temperature in ice water. The aqueous solution of the binder composition listed in Synthesis Example 8 above adjusted in advance to a nonvolatile content concentration of 4% was added in the amount of 10.5 parts by weight (0.42 parts by weight in terms of nonvolatile content) and mixed until the entire mixture was homogeneous. Subsequently, the mixture was stirred for 2 minutes in a planetary centrifugal mixer (ARE-310 available from Thinky Corporation) at 1000 rpm for rotation and 2000 rpm for revolution and cooled to room temperature in ice water. With the addition of 6 parts by weight of distilled water and 2.99 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%), the mixture was stirred again for 30 seconds in a planetary centrifugal mixer (ARE-310 available from Thinky Corporation) at 1000 rpm for rotation and 2000 rpm for revolution to prepare a negative electrode mixture slurry.

### Slurry Preparation Example 19

In a planetary centrifugal mixer (ARE-310 available from Thinky Corporation), 3.7 parts by weight of SiO negative electrode material (initial charge capacity 2062 mAh/g, initial discharge capacity 1631 mAh/g), 92.3 parts by weight of artificial graphite (initial charge capacity 390 mAh/g, initial discharge capacity 350 mAh/g), and 1.0 part by weight of acetylene black were stirred for 30 seconds at 1000 rpm for rotation and 2000 rpm for revolution. The binder composition synthesized in Synthesis Example 8 above (HEA/AA/AAM=20/20/60, ammonium salt, weight average molecular weight 780000, nonvolatile content concentration 15.0%) was dissolved in distilled water to adjust the nonvolatile content concentration to 4.0%, and 27.0 parts by weight (1.08 parts by weight in terms of solid content) of the aqueous solution was mixed with 21.0 parts by weight of distilled water until the entire mixture became a paste. Subsequently, the mixture was stirred for 2 minutes in a planetary centrifugal mixer (ARE-310 available from Thinky Corporation) at 1000 rpm for rotation and 2000 rpm for revolution, and the mixture, which was heated by the stirring, was cooled to room temperature in ice water. The mixture was stirred again at 1000 rpm for rotation and 2000 rpm for revolution for 2 minutes, and then cooled to room temperature in ice water. The aqueous solution of the binder composition synthesized in Synthesis Example 8 above adjusted in advance to a nonvolatile content concentration of 4% was added in the amount of 10.5 parts by weight (0.42 parts by weight in terms of nonvolatile content) and mixed until the entire mixture was homogeneous. Subsequently, the mixture was stirred for 2 minutes in a planetary centrifugal mixer (ARE-310 available from Thinky Corporation) at 1000 rpm for rotation and 2000 rpm for revolution and cooled to room temperature in ice water. With the addition of 7 parts by weight of distilled water and 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%), the mixture was stirred again for 30 seconds in a planetary centrifugal mixer (ARE-310 available from Thinky Corporation) at 1000 rpm for rotation and 2000 rpm for revolution to prepare a negative electrode mixture slurry.

### Slurry Preparation Example 20

A negative electrode mixture slurry was prepared completely in the same manner as in Slurry Preparation Example 19, except that 5.3 parts by weight of SiO negative electrode material (initial charge capacity 2062 mAh/g, initial discharge capacity 1631 mAh/g) and 90.7 parts by weight of artificial graphite (initial charge capacity 390 mAh/g, initial discharge capacity 350 mAh/g) were used.

### Slurry Preparation Example 21

In a planetary centrifugal mixer (ARE-310 available from Thinky Corporation), 96.0 parts by weight of artificial graphite (initial charge capacity 390 mAh/g, initial discharge capacity 350 mAh/g) and 1.0 part by weight of acetylene black were stirred for 30 seconds at 1000 rpm for rotation and 2000 rpm for revolution. An aqueous solution of carboxymethyl cellulose sodium salt (CMC, SUNROSE MAC350HC available from Nippon Paper Industries Co., Ltd.) dissolved in distilled water and adjusted to a nonvolatile content concentration of 2.0% was added in the amount of 48.0 parts by weight (0.96 parts by weight in terms of solid content) and mixed until the entire mixture became a paste. Subsequently, the mixture was stirred for 2 minutes in a planetary centrifugal mixer (ARE-310 available from Thinky Corporation) at 1000 rpm for rotation and 2000 rpm for revolution, and the mixture, which was heated by the stirring, was cooled to room temperature in ice water. The mixture was stirred again at 1000 rpm for rotation and 2000 rpm for revolution for 2 minutes, and then cooled to room temperature in ice water. The aqueous solution of CMC adjusted in advance to a nonvolatile content concentration of 2% was added in the amount of 27.0 parts by weight (0.54 parts by weight in terms of nonvolatile content) and mixed until the entire mixture was homogeneous. Subsequently, the mixture was stirred for 2 minutes in a planetary centrifugal mixer (ARE-310 available from Thinky Corporation) at 1000 rpm for rotation and 2000 rpm for revolution and cooled to room temperature in ice water. With the addition of 20 parts by weight of distilled water and 2.95 parts by weight of a styrene-butadiene copolymer (SBR) (DS407H available from DIC Corporation, nonvolatile content concentration 50.8%), the mixture was stirred again for 30 seconds in a planetary centrifugal mixer (ARE-310 available from Thinky Corporation) at 1000 rpm for rotation and 2000 rpm for revolution to prepare a negative electrode mixture slurry.

### Slurry Preparation Example 22

In a planetary centrifugal mixer (ARE-310 available from Thinky Corporation), 96.0 parts by weight of artificial graphite (initial charge capacity 390 mAh/g, initial discharge capacity 350 mAh/g) and 1.0 part by weight of acetylene black were stirred for 30 seconds at 1000 rpm for rotation and 2000 rpm for revolution. The binder composition synthesized in Synthesis Example 1 above (HEA/AA=60/40, Na salt, weight average molecular weight 850000, nonvolatile content concentration 14.8%) was diluted with distilled water to adjust the nonvolatile content concentration to 8.0%, and 27.0 parts by weight (2.16 parts by weight in terms of solid content) of the diluted aqueous solution was mixed with 21.0 parts by weight of distilled water until the entire mixture became a paste. Subsequently, the mixture was stirred for 2 minutes in a planetary centrifugal mixer (ARE-310 available from Thinky Corporation) at 1000 rpm for rotation and 2000 rpm for revolution, and the mixture, which was heated by the stirring, was cooled to room temperature in ice water. The mixture was stirred again at 1000 rpm for rotation and 2000 rpm for revolution for 2 minutes, and then cooled to room temperature in ice water. The aqueous solution of the binder composition synthesized in Synthesis Example 7 above adjusted in advance to a nonvolatile content concentration of 8.0% was added in the amount of 10.5 parts by weight (0.84 parts by weight in terms of nonvolatile content) and mixed until the entire mixture was homogeneous. Subsequently, the mixture was stirred for 2 minutes in a planetary centrifugal mixer (ARE-310 available from Thinky Corporation) at 1000 rpm for rotation and 2000 rpm for revolution and cooled to room temperature in ice water. With the addition of 7 parts by weight of distilled water, the mixture was stirred again for 30 seconds in a planetary centrifugal mixer (ARE-310 available from Thinky Corporation) at 1000 rpm for rotation and 2000 rpm for revolution to prepare a negative electrode mixture slurry.

### Slurry Preparation Example 23

A negative electrode mixture slurry was prepared completely in the same manner as in Slurry Preparation Example 21, except that 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%) was used instead of SBR.

### Slurry Preparation Example 24

A negative electrode mixture slurry was prepared completely in the same manner as in Slurry Preparation Example 1, except that the binder composition synthesized in Synthesis Example 2 (HBA/AA=60/40, Na salt, weight average molecular weight 480000, nonvolatile content concentration 15.0%) was used instead of Synthesis Example 1 and 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%) was used instead of SBR.

### Slurry Preparation Example 25

A negative electrode mixture slurry was prepared completely in the same manner as in Slurry Preparation Example 1, except that the binder composition synthesized in Synthesis Example 3 (HBA/AA=75/35, Na salt, weight average molecular weight 750000, nonvolatile content concentration 14.9%) was used instead of Synthesis Example 1 and 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%) was used instead of SBR.

### Slurry Preparation Example 26

A negative electrode mixture slurry was prepared completely in the same manner as in Slurry Preparation Example 1, except that the binder composition synthesized in Synthesis Example 6 (HBA/AA=60/40, no neutralization, weight average molecular weight 830000, nonvolatile content concentration 15.0%) was used instead of Synthesis Example 1 and 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%) was used instead of SBR.

### Slurry Preparation Example 27

A negative electrode mixture slurry was prepared completely in the same manner as in Slurry Preparation Example 1, except that the binder composition synthesized in Synthesis Example 16 (HEA/AAM=70/30, Na salt, weight average molecular weight 750000, nonvolatile content concentration 15.0%) was used instead of Synthesis Example 1 and 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%) was used instead of SBR.

### Slurry Preparation Example 28

A negative electrode mixture slurry was prepared completely in the same manner as in Slurry Preparation Example 1, except that the binder composition synthesized in Synthesis Example 17 (AA/AAM=70/30, Na salt, weight average molecular weight 820000, nonvolatile content concentration 15.0%) was used instead of Synthesis Example 1 and 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%) was used instead of SBR.

### Slurry Preparation Example 29

A negative electrode mixture slurry was prepared completely in the same manner as in Slurry Preparation Example 1, except that polyacrylic acid sodium salt (Wako Pure Chemical Corporation, degree of polymerization 22000 to 70000) was used instead of Synthesis Example 1 and 3.73 parts by weight of the aqueous latex resin (Y) synthesized in Synthesis Example 18 (ST/BA/HEMA/MMA/AAM/GMA=54.5/30/8/5/2/0.5, nonvolatile content concentration 40.2%) was used instead of SBR.

### Slurry Preparation Example 30

In a planetary centrifugal mixer (ARE-310 available from Thinky Corporation), 95.0 parts by weight of artificial graphite (initial charge capacity 390 mAh/g, initial discharge capacity 350 mAh/g), 1.0 part by weight of acetylene black, and 2.0 parts by weight of carboxymethyl cellulose sodium salt (CMC, SUNROSE MAC350HC available from Nippon Paper Industries Co., Ltd.) were stirred for 30 seconds at 1000 rpm for rotation and 2000 rpm for revolution. Then, 48.0 parts by weight of distilled water was added and mixed until the entire mixture became a paste. Subsequently, the mixture was stirred for 2 minutes in a planetary centrifugal mixer (ARE-310 available from Thinky Corporation) at 1000 rpm for rotation and 2000 rpm for revolution, and the mixture, which was heated by the stirring, was cooled to room temperature in ice water. The mixture was stirred again at 1000 rpm for rotation and 2000 rpm for revolution for 2 minutes, and then cooled to room temperature in ice water. Then, 10.5 parts by weight of distilled water was added and mixed until the entire mixture was homogeneous. Subsequently, the mixture was stirred for 2 minutes in a planetary centrifugal mixer (ARE-310 available from Thinky Corporation) at 1000 rpm for rotation and 2000 rpm for revolution and cooled to room temperature in ice water. With the addition of 25 parts by weight of distilled water and 3.94 parts by weight of a styrene-butadiene copolymer (SBR) (DS407H available from DIC Corporation, nonvolatile content concentration 50.8%), the mixture was stirred again for 30 seconds in a planetary centrifugal mixer (ARE-310 available from Thinky Corporation) at 1000 rpm for rotation and 2000 rpm for revolution to prepare a negative electrode mixture slurry.

### Slurry Preparation Example 31

In a planetary centrifugal mixer (ARE-310 available from Thinky Corporation), 96.6 parts by weight of artificial graphite (initial charge capacity 390 mAh/g, initial discharge capacity 350 mAh/g), 1.0 part by weight of acetylene black, and 1.2 parts by weight of carboxymethyl cellulose sodium salt (CMC, SUNROSE MAC350HC available from Nippon Paper Industries Co., Ltd.) were stirred for 30 seconds at 1000 rpm for rotation and 2000 rpm for revolution. Then, 48.0 parts by weight of distilled water was added and mixed until the entire mixture became a paste. Subsequently, the mixture was stirred for 2 minutes in a planetary centrifugal mixer (ARE-310 available from Thinky Corporation) at 1000 rpm for rotation and 2000 rpm for revolution, and the mixture, which was heated by the stirring, was cooled to room temperature in ice water. The mixture was stirred again at 1000 rpm for rotation and 2000 rpm for revolution for 2 minutes, and then cooled to room temperature in ice water. Then, 10.5 parts by weight of distilled water (0.42 parts by weight in terms of nonvolatile content) was added and mixed until the entire mixture was homogeneous. Subsequently, the mixture was stirred for 2 minutes in a planetary centrifugal mixer (ARE-310 available from Thinky Corporation) at 1000 rpm for rotation and 2000 rpm for revolution and cooled to room temperature in ice water. With the addition of 20 parts by weight of distilled water and 2.36 parts by weight of a styrene-butadiene copolymer (SBR) (DS407H available from DIC Corporation, nonvolatile content concentration 50.8%), the mixture was stirred again for 30 seconds in a planetary centrifugal mixer (ARE-310 available from Thinky Corporation) at 1000 rpm for rotation and 2000 rpm for revolution to prepare a negative electrode mixture slurry.

### Slurry Preparation Example 32

In a planetary centrifugal mixer (ARE-310 available from Thinky Corporation), 3.7 parts by weight of SiO negative electrode material (initial charge capacity 2062 mAh/g, initial discharge capacity 1631 mAh/g), 92.3 parts by weight of artificial graphite (initial charge capacity 390 mAh/g, initial discharge capacity 350 mAh/g), and 1.0 part by weight of acetylene black were stirred for 30 seconds at 1000 rpm for rotation and 2000 rpm for revolution. An aqueous solution of carboxymethyl cellulose sodium salt (CMC, SUNROSE MAC350HC available from Nippon Paper Industries Co., Ltd.) dissolved in distilled water and adjusted to a nonvolatile content concentration of 2.0% was added in the amount of 48.0 parts by weight (0.96 parts by weight in terms of solid content) and mixed until the entire mixture became a paste. Subsequently, the mixture was stirred for 2 minutes in a planetary centrifugal mixer (ARE-310 available from Thinky Corporation) at 1000 rpm for rotation and 2000 rpm for revolution, and the mixture, which was heated by the stirring, was cooled to room temperature in ice water. The mixture was stirred again at 1000 rpm for rotation and 2000 rpm for revolution for 2 minutes, and then cooled to room temperature in ice water. The aqueous solution of CMC adjusted in advance to a nonvolatile content concentration of 2% was added in the amount of 27.0 parts by weight (0.54 parts by weight in terms of nonvolatile content) and mixed until the entire mixture was homogeneous. Subsequently, the mixture was stirred for 2 minutes in a planetary centrifugal mixer (ARE-310 available from Thinky Corporation) at 1000 rpm for rotation and 2000 rpm for revolution and cooled to room temperature in ice water. With the addition of 20 parts by weight of distilled water and 2.95 parts by weight of a styrene-butadiene copolymer (SBR) (DS407H available from DIC Corporation, nonvolatile content concentration 50.8%), the mixture was stirred again for 30 seconds in a planetary centrifugal mixer (ARE-310 available from Thinky Corporation) at 1000 rpm for rotation and 2000 rpm for revolution to prepare a negative electrode mixture slurry.

### Slurry Preparation Example 33

A negative electrode mixture slurry was prepared completely in the same manner as in Slurry Preparation Example 32, except that 5.3 parts by weight of SiO negative electrode material (initial charge capacity 2062 mAh/g, initial discharge capacity 1631 mAh/g) and 91.3 parts by weight of artificial graphite (initial charge capacity 390 mAh/g, initial discharge capacity 350 mAh/g) were used.

### “Preparation of Negative Electrode”

### Example 1

The gap of a bar coater was adjusted so that the coating amount (surface density) of the negative electrode mixture after drying was 13.2 mg/cm², and the negative electrode mixture slurry prepared in Slurry Preparation Example 1 was applied onto electrolytic copper foil (10 μm thick, 180 mm wide) as a current collector using this bar coater. The coating was then dried in a blower dryer set at 80° C. for 8 minutes. The dried electrode was cut into a strip 40 mm wide, which was pressed using a roll press machine (small tabletop roll press SA-602 manufactured by Tester Sangyo Co., Ltd.) so that the density of the mixture layer was 1.70 g/cm³ (77.6 μm in thickness of the mixture layer). After vacuum drying at 110° C. for 10 hours, the density of the mixture layer was measured again and was 1.65 g/cm³ (80.0 μm in thickness of the mixture layer). The initial charge capacity per unit area of this electrode is 4.97 mAh/cm². The negative electrode of Example 1 was thus obtained (surface density 13.2 gm/cm², mixture layer density 1.65 g/cm³, mixture layer thickness 80.0 μm, unit area initial charge capacity 4.97 mAh/cm²).

### (Measurement of Peel Strength and Determination of Winding Resistance of Electrode)

The negative electrode prepared as described above was left in a constant-temperature, constant-humidity room at a temperature of 25° C. and a relative humidity of 50% for 6 hours, and then cut into a strip 25 mm wide and 100 mm long. The active material surface as a bonded surface was then affixed to a stainless steel plate using double-sided tape (No. 5015 available from Nitto Denko Corporation) to make a sample for peel strength testing. An end portion of the copper foil was peeled off about 10 mm, to which polyimide tape was bonded to serve as an attachment point to a peel tester. The sample for peel strength testing was mounted on a peel tester (Autograph AG-X Plus available from Shimadzu Corporation), and 180-degree peel testing was performed. The peel strength was 34.5 N/m. Then, the state of peeling (breakage) of the negative electrode coating was observed. The negative electrode coating was wound around a core with a diameter of 5 mm, and whether cracking appeared in the coating was visually observed. There was no cracking at this time.

### Example 2

A negative electrode of Example 2 (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 2 above was used. The pressure of the roll press was adjusted as appropriate so that the density of the mixture layer after vacuum drying was 1.65 g/cm³ (80.0 μm in thickness of the mixture layer). The peel strength at this time was 31.5 N/m. No cracking was observed when the negative electrode coating was wound around a core having a diameter of 5 mm.

### Example 3

A negative electrode of Example 3 (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 3 above was used. The pressure of the roll press was adjusted as appropriate so that the density of the mixture layer after vacuum drying was 1.65 g/cm³ (80.0 μm in thickness of the mixture layer). The peel strength at this time was 27.8 N/m. No cracking was observed when the negative electrode coating was wound around a core having a diameter of 5 mm.

### Example 4

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 4 above was used. The pressure of the roll press was adjusted as appropriate so that the density of the mixture layer after vacuum drying was 1.65 g/cm³ (80.0 μm in thickness of the mixture layer). The peel strength at this time was 28.9 N/m. No cracking was observed when the negative electrode coating was wound around a core having a diameter of 5 mm.

### Example 5

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 5 above was used. The pressure of the roll press was adjusted as appropriate so that the density of the mixture layer after vacuum drying was 1.65 g/cm³ (80.0 μm in thickness of the mixture layer). The peel strength at this time was 28.9 N/m. No cracking was observed when the negative electrode coating was wound around a core having a diameter of 5 mm.

### Example 6

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 6 above was used. The pressure of the roll press was adjusted as appropriate so that the density of the mixture layer after vacuum drying was 1.65 g/cm³ (80.0 μm in thickness of the mixture layer). The peel strength at this time was 30.7 N/m. No cracking was observed when the negative electrode coating was wound around a core having a diameter of 5 mm.

### Example 7

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 7 above was used. The pressure of the roll press was adjusted as appropriate so that the density of the mixture layer after vacuum drying was 1.65 g/cm³ (80.0 μm in thickness of the mixture layer). The peel strength at this time was 28.4 N/m. No cracking was observed when the negative electrode coating was wound around a core having a diameter of 5 mm.

### Example 8

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 8 above was used. The pressure of the roll press was adjusted as appropriate so that the density of the mixture layer after vacuum drying was 1.65 g/cm³ (80.0 μm in thickness of the mixture layer). The peel strength at this time was 29.1 N/m. No cracking was observed when the negative electrode coating was wound around a core having a diameter of 5 mm.

### Example 9

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 9 above was used. The pressure of the roll press was adjusted as appropriate so that the density of the mixture layer after vacuum drying was 1.65 g/cm³ (80.0 μm in thickness of the mixture layer). The peel strength at this time was 30.5 N/m. No cracking was observed when the negative electrode coating was wound around a core having a diameter of 5 mm.

### Example 10

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 10 above was used. The pressure of the roll press was adjusted as appropriate so that the density of the mixture layer after vacuum drying was 1.65 g/cm³ (80.0 μm in thickness of the mixture layer). The peel strength at this time was 28.6 N/m. No cracking was observed when the negative electrode coating was wound around a core having a diameter of 5 mm.

### Example 11

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 11 above was used. The pressure of the roll press was adjusted as appropriate so that the density of the mixture layer after vacuum drying was 1.65 g/cm³ (80.0 μm in thickness of the mixture layer). The peel strength at this time was 28.6 N/m. No cracking was observed when the negative electrode coating was wound around a core having a diameter of 5 mm.

### Example 12

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 12 above was used. The pressure of the roll press was adjusted as appropriate so that the density of the mixture layer after vacuum drying was 1.65 g/cm³ (80.0 μm in thickness of the mixture layer). The peel strength at this time was 30.1 N/m. No cracking was observed when the negative electrode coating was wound around a core having a diameter of 5 mm.

### Example 13

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 13 above was used. The pressure of the roll press was adjusted as appropriate so that the density of the mixture layer after vacuum drying was 1.65 g/cm³ (80.0 μm in thickness of the mixture layer). The peel strength at this time was 32 N/m. No cracking was observed when the negative electrode coating was wound around a core having a diameter of 5 mm.

### Example 14

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 14 above was used. The pressure of the roll press was adjusted as appropriate so that the density of the mixture layer after vacuum drying was 1.65 g/cm³ (80.0 μm in thickness of the mixture layer). The peel strength at this time was 29.8 N/m. No cracking was observed when the negative electrode coating was wound around a core having a diameter of 5 mm.

### Example 15

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 15 above was used. The pressure of the roll press was adjusted as appropriate so that the density of the mixture layer after vacuum drying was 1.65 g/cm³ (80.0 μm in thickness of the mixture layer). The peel strength at this time was 29.5 N/m. No cracking was observed when the negative electrode coating was wound around a core having a diameter of 5 mm.

### Example 16

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 16 above was used. The pressure of the roll press was adjusted as appropriate so that the density of the mixture layer after vacuum drying was 1.65 g/cm³ (80.0 μm in thickness of the mixture layer). The peel strength at this time was 34.6 N/m. No cracking was observed when the negative electrode coating was wound around a core having a diameter of 5 mm.

### Example 17

A negative electrode (surface density 13.2 gm/cm², mixture layer density 1.65 g/cm³, mixture layer thickness 80.0 μm, unit area initial charge capacity 4.89 mAh/cm²) was prepared completely in the same manner as in Example 1, except that the negative electrode mixture slurry described in Slurry Preparation Example 17 above was used. The pressure of the roll press was adjusted as appropriate so that the density of the mixture layer after vacuum drying was 1.65 g/cm³ (80.0 μm in thickness of the mixture layer). The peel strength at this time was 56.0 N/m. No cracking was observed when the negative electrode coating was wound around a core having a diameter of 5 mm.

### Example 18

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 18 above was used. The pressure of the roll press was adjusted as appropriate so that the density of the mixture layer after vacuum drying was 1.65 g/cm³ (80.0 μm in thickness of the mixture layer). The peel strength at this time was 16.2 N/m. No cracking was observed when the negative electrode coating was wound around a core having a diameter of 5 mm.

### Example 19

A negative electrode (surface density 13.2 gm/cm², mixture layer density 1.40 g/cm³, mixture layer thickness 94.3 μm, unit area initial charge capacity 4.97 mAh/cm²) was prepared completely in the same manner as in Example 1, except that the negative electrode mixture slurry described in Slurry Preparation Example 6 above was used and the pressure of the roll press was adjusted as appropriate so that the electrode density after vacuum drying was 1.40 g/cm³ (94.3 μm in thickness of the mixture layer). The peel strength at this time was 29.0 N/m. No cracking was observed when the negative electrode coating was wound around a core having a diameter of 5 mm.

### Example 20

A negative electrode (surface density 13.2 gm/cm², mixture layer density 1.75 g/cm³, mixture layer thickness 75.4 μm, unit area initial charge capacity 4.97 mAh/cm²) was prepared completely in the same manner as in Example 1, except that the negative electrode mixture slurry described in Slurry Preparation Example 6 above was used and the pressure of the roll press was adjusted as appropriate so that the electrode density after vacuum drying was 1.75 g/cm³ (75.4 μm in thickness of the mixture layer). The peel strength at this time was 35.2 N/m. No cracking was observed when the negative electrode coating was wound around a core having a diameter of 5 mm.

### Example 21

A negative electrode (surface density 18.2 gm/cm², mixture layer density 1.65 g/cm³, mixture layer thickness 110.0 μm, unit area initial charge capacity 6.81 mAh/cm²) was prepared completely in the same manner as in Example 1, except that the negative electrode mixture slurry described in Slurry Preparation Example 6 above was used and the gap of the bar coater was adjusted so that the coating amount (surface density) of the negative electrode mixture was 18.2 mg/cm². The pressure of the roll press was adjusted as appropriate so that the density of the mixture layer after vacuum drying was 1.65 g/cm³ (110.3 μm in thickness of the mixture layer). The peel strength at this time was 30.1 N/m. No cracking was observed when the negative electrode coating was wound around a core having a diameter of 5 mm.

### Example 22

A negative electrode (surface density 20.7 gm/cm², mixture layer density 1.65 g/cm³, mixture layer thickness 125.5 μm, unit area initial charge capacity 7.75 mAh/cm²) was prepared completely in the same manner as in Example 1, except that the negative electrode mixture slurry described in Slurry Preparation Example 6 above was used and the gap of the bar coater was adjusted so that the coating amount (surface density) of the negative electrode mixture was 20.7 mg/cm². The pressure of the roll press was adjusted as appropriate so that the density of the mixture layer after vacuum drying was 1.65 g/cm³ (125.5 μm in thickness of the mixture layer). The peel strength at this time was 25.5 N/m. No cracking was observed when the negative electrode coating was wound around a core having a diameter of 5 mm.

### Example 23

A negative electrode (surface density 11.3 gm/cm cm², mixture layer density 1.65 g/cm³, mixture layer thickness 68.5 μm, unit area initial charge capacity 4.94 mAh/cm²) was prepared completely in the same manner as in Example 1, except that the negative electrode mixture slurry described in Slurry Preparation Example 19 above was used, the gap of the bar coater was adjusted so that the coating amount (surface density) of the negative electrode mixture was 11.3 mg/cm², and the pressure of the roll press was adjusted as appropriate so that the electrode density after vacuum drying was 1.65 g/cm³ (68.5 μm in thickness of the mixture layer). The peel strength at this time was 32.0 N/m. No cracking was observed when the negative electrode coating was wound around a core having a diameter of 5 mm.

### Example 24

A negative electrode (surface density 10.7 gm/cm², mixture layer density 1.65 g/cm³, mixture layer thickness 64.8 μm, unit area initial charge capacity 4.98 mAh/cm²) was prepared completely in the same manner as in Example 1, except that the negative electrode mixture slurry described in Slurry Preparation Example 20 above was used, the gap of the bar coater was adjusted so that the coating amount (surface density) of the negative electrode mixture was 10.7 mg/cm², and the pressure of the roll press was adjusted as appropriate so that the electrode density after vacuum drying was 1.65 g/cm³ (64.8 μm in thickness of the mixture layer). The peel strength at this time was 34.0 N/m. No cracking was observed when the negative electrode coating was wound around a core having a diameter of 5 mm.

### Comparative Example 1

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 21 above was used. The pressure of the roll press was adjusted as appropriate so that the density of the mixture layer after vacuum drying was 1.65 g/cm³ (80.0 μm in thickness of the mixture layer). The peel strength at this time was 16.8 N/m. No cracking was observed when the negative electrode coating was wound around a core having a diameter of 5 mm.

### Comparative Example 2

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 22 above was used. The pressure of the roll press was adjusted as appropriate so that the density of the mixture layer after vacuum drying was 1.65 g/cm³ (80.0 μm in thickness of the mixture layer). The peel strength at this time was 38.0 N/m. No cracking was observed when the negative electrode coating was wound around a core having a diameter of 5 mm.

### Comparative Example 3

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 23 above was used. The pressure of the roll press was adjusted as appropriate so that the density of the mixture layer after vacuum drying was 1.65 g/cm³ (80.0 μm in thickness of the mixture layer). The peel strength at this time was 14.8 N/m. No cracking was observed when the negative electrode coating was wound around a core having a diameter of 5 mm.

### Comparative Example 4

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 24 above was used. The pressure of the roll press was adjusted as appropriate so that the density of the mixture layer after vacuum drying was 1.65 g/cm³ (80.0 μm in thickness of the mixture layer). The peel strength at this time was 17.4 N/m. No cracking was observed when the negative electrode coating was wound around a core having a diameter of 5 mm.

### Comparative Example 5

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 25 above was used. The pressure of the roll press was adjusted as appropriate so that the density of the mixture layer after vacuum drying was 1.65 g/cm³ (80.0 μm in thickness of the mixture layer). The peel strength at this time was 14.5 N/m. No cracking was observed when the negative electrode coating was wound around a core having a diameter of 5 mm.

### Comparative Example 6

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 26 above was used. The pressure of the roll press was adjusted as appropriate so that the density of the mixture layer after vacuum drying was 1.65 g/cm³ (80.0 μm in thickness of the mixture layer). The peel strength at this time was 18.0 N/m. No cracking was observed when the negative electrode coating was wound around a core having a diameter of 5 mm.

### Comparative Example 7

A negative electrode was prepared completely in the same manner as in Example 1, except that the negative electrode mixture slurry described in Slurry Preparation Example 27 above (surface density 13.2 gm/cm², mixture layer density 1.65 g/cm³, mixture layer thickness 80.0 μm, unit area initial charge capacity 4.97 mAh/cm²) was used. The pressure of the roll press was adjusted as appropriate so that the density of the mixture layer after vacuum drying was 1.65 g/cm³ (80.0 μm in thickness of the mixture layer). The peel strength at this time was 15.2 N/m. No cracking was observed when the negative electrode coating was wound around a core having a diameter of 5 mm.

### Comparative Example 8

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 28 above was used. The pressure of the roll press was adjusted as appropriate so that the density of the mixture layer after vacuum drying was 1.65 g/cm³ (80.0 μm in thickness of the mixture layer). The peel strength at this time was 14.5 N/m. No cracking was observed when the negative electrode coating was wound around a core having a diameter of 5 mm.

### Comparative Example 9

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 29 above was used. The pressure of the roll press was adjusted as appropriate so that the density of the mixture layer after vacuum drying was 1.65 g/cm³ (80.0 μm in thickness of the mixture layer). The peel strength at this time was 16.4 N/m. No cracking was observed when the negative electrode coating was wound around a core having a diameter of 5 mm.

### Comparative Example 10

A negative electrode (surface density 13.2 gm/cm², mixture layer density 1.65 g/cm³, mixture layer thickness 80.0 μm, unit area initial charge capacity 4.89 mAh/cm²) was prepared completely in the same manner as in Example 1, except that the negative electrode mixture slurry described in Slurry Preparation Example 17 above was used. The pressure of the roll press was adjusted as appropriate so that the density of the mixture layer after vacuum drying was 1.65 g/cm³ (80.0 μm in thickness of the mixture layer). The peel strength at this time was 56.0 N/m. No cracking was observed when the negative electrode coating was wound around a core having a diameter of 5 mm.

### Comparative Example 11

A negative electrode (surface density 13.2 gm/cm², mixture layer density 1.65 g/cm³, mixture layer thickness 80.0 μm, unit area initial charge capacity 4.97 mAh/cm²) was prepared completely in the same manner as in Example 1, except that the negative electrode mixture slurry described in Slurry Preparation Example 18 above was used. The pressure of the roll press was adjusted as appropriate so that the density of the mixture layer after vacuum drying was 1.65 g/cm³ (80.0 μm in thickness of the mixture layer). The peel strength at this time was 16.2 N/m. No cracking was observed when the negative electrode coating was wound around a core having a diameter of 5 mm.

### Comparative Example 12

A negative electrode (surface density 13.2 gm/cm², mixture layer density 1.40 g/cm³, mixture layer thickness 94.3 μm, unit area initial charge capacity 4.97 mAh/cm²) was prepared completely in the same manner as in Example 1, except that the negative electrode mixture slurry described in Slurry Preparation Example 21 above was used and the pressure of the roll press was adjusted as appropriate so that the electrode density after vacuum drying was 1.40 g/cm³ (94.3 μm in thickness of the mixture layer). The pressure of the roll press was adjusted as appropriate so that the density of the mixture layer after vacuum drying was 1.40 g/cm³ (94.3 μm in thickness of the mixture layer). The peel strength at this time was 14.6 N/m. No cracking was observed when the negative electrode coating was wound around a core having a diameter of 5 mm.

### Comparative Example 13

A negative electrode (surface density 13.2 gm/cm², mixture layer density 1.75 g/cm³, mixture layer thickness 75.4 μm, unit area initial charge capacity 4.97 mAh/cm²) was prepared completely in the same manner as in Example 1, except that the negative electrode mixture slurry described in Slurry Preparation Example 21 above was used and the pressure of the roll press was adjusted as appropriate so that the electrode density after vacuum drying was 1.75 g/cm³ (75.4 μm in thickness of the mixture layer). The pressure of the roll press was adjusted as appropriate so that the density of the mixture layer after vacuum drying was 1.75 g/cm³ (75.4 μm in thickness of the mixture layer). The peel strength at this time was 18.2 N/m. No cracking was observed when the negative electrode coating was wound around a core having a diameter of 5 mm.

### Comparative Example 14

A negative electrode (surface density 18.2 gm/cm², mixture layer density 1.65 g/cm³, mixture layer thickness 110.0 μm, unit area initial charge capacity 6.18 mAh/cm²) was prepared completely in the same manner as in Example 1, except that the negative electrode mixture slurry described in Slurry Preparation Example 21 above was used and the gap of the bar coater was adjusted so that the coating amount (surface density) of the negative electrode mixture was 18.2 mg/cm². The pressure of the roll press was adjusted as appropriate so that the density of the mixture layer after vacuum drying was 1.65 g/cm³ (110.0 μm in thickness of the mixture layer). The peel strength at this time was 20.0 N/m. No cracking was observed when the negative electrode coating was wound around a core having a diameter of 5 mm.

### Comparative Example 15

A negative electrode (surface density 20.7 gm/cm², mixture layer density 1.65 g/cm³, mixture layer thickness 125.5 μm, unit area initial charge capacity 7.75 mAh/cm²) was prepared completely in the same manner as in Example 1, except that the negative electrode mixture slurry described in Slurry Preparation Example 21 above was used and the gap of the bar coater was adjusted so that the coating amount (surface density) of the negative electrode mixture was 20.7 mg/cm². The pressure of the roll press was adjusted as appropriate so that the density of the mixture layer after vacuum drying was 1.65 g/cm³ (125.5 μm in thickness of the mixture layer). The peel strength at this time was 13.2 N/m. No cracking was observed when the negative electrode coating was wound around a core having a diameter of 5 mm.

### Comparative Example 16

A negative electrode (surface density 11.3 gm/cm², mixture layer density 1.65 g/cm³, mixture layer thickness 68.5 μm, unit area initial charge capacity 4.94 mAh/cm²) was prepared completely in the same manner as in Example 1, except that the negative electrode mixture slurry described in Slurry Preparation Example 30 above was used, the gap of the bar coater was adjusted so that the coating amount (surface density) of the negative electrode mixture was 11.3 mg/cm², and the pressure of roll press was adjusted as appropriate so that the electrode density after vacuum drying was 1.65 g/cm³ (68.5 μm in thickness of the mixture layer). The peel strength at this time was 20.3 N/m. No cracking was observed when the negative electrode coating was wound around a core having a diameter of 5 mm.

### Comparative Example 17

A negative electrode (surface density 10.7 gm/cm², mixture layer density 1.65 g/cm³, mixture layer thickness 64.8 μm, unit area initial charge capacity 4.98 mAh/cm²) was prepared completely in the same manner as in Example 1, except that the negative electrode mixture slurry described in Slurry Preparation Example 31 above was used, the gap of the bar coater was adjusted so that the coating amount (surface density) of the negative electrode mixture was 10.7 mg/cm², and the pressure of the roll press was adjusted as appropriate so that the electrode density after vacuum drying was 1.65 g/cm³ (64.8 μm in thickness of the mixture layer). The peel strength at this time was 22.5 N/m. No cracking was observed when the negative electrode coating was wound around a core having a diameter of 5 mm.

### “Preparation of Positive Electrode”

### “Preparation of Positive Electrode Mixture Slurry”

A positive electrode mixture slurry was formed by dispersing 94.0 parts by weight of positive electrode material LiMn0.6Co0.2Ni0.2O2 (initial charge capacity 191 mAh/g, initial discharge capacity 171 mAh/g), 3.0 parts by weight of acetylene black, and 3.0 parts by weight of polyvinylidene fluoride in N-methyl-2-pyrrolidone. The nonvolatile content in the positive electrode mixture slurry was 50 parts by weight of the total slurry mass.

In a dry room with a dew point controlled to −30° C. or lower, 94.0 parts by weight of positive electrode material LiMn0.6Co0.2Ni0.2O2 (initial charge capacity 191 mAh/g, initial discharge capacity 171 mAh/g) and 3.0 parts by weight of acetylene black were stirred for 30 seconds in a planetary centrifugal mixer (ARE-310 available from Thinky Corporation) at 1000 rpm for rotation and 2000 rpm for revolution. A 10% NMP solution of polyvinylidene fluoride (PVDF #1100 available from KUREHA CORPORATION) was added in the amount of 30.0 parts by weight (3.0 parts by weight in terms of solid content) and mixed until the entire mixture became a paste. Subsequently, the mixture was stirred for 1 minute in a planetary centrifugal mixer (ARE-310 available from Thinky Corporation) at 1000 rpm for rotation and 2000 rpm for revolution. The mixture, which was heated by the stirring, was allowed to cool to room temperature. The stirring by the planetary centrifugal mixer and the cooling were repeated three more times. Next, 10.0 parts by weight of NMP was added and mixed until the entire mixture was homogeneous. Subsequently, the mixture was stirred for 1 minute in a planetary centrifugal mixer (ARE-310 available from Thinky Corporation) at 1000 rpm for rotation and 2000 rpm for revolution. The mixture, which was heated by the stirring, was allowed to cool to room temperature. The stirring by the planetary centrifugal mixer and the cooling were repeated three more times. Next, 10.0 parts by weight of NMP was added, and the mixture was stirred for 2 minutes in a planetary centrifugal mixer (ARE-310 available from Thinky Corporation) at 1000 rpm for rotation and 2000 rpm for revolution to prepare a positive electrode mixture slurry.

### Positive Electrode Preparation Example 1

“Preparation of Positive Electrode with Surface Density of 25.0 mg/cm²”

First, the gap of a bar coater was adjusted so that the coating amount (surface density) of the mixture after drying was 25.0 mg/cm², and the positive electrode mixture slurry prepared above was applied onto aluminum current collector foil (15 μm thick, 180 mm wide) as a current collector using this bar coater. The positive electrode mixture slurry was then dried in a blower dryer set at 80° C. for 15 minutes. The dried positive electrode mixture was then pressed by a roll press machine so that the mixture density was 3.40 g/cm³. Finally, the positive electrode mixture was vacuum-dried at 110° C. for 10 hours to prepare a positive electrode with a surface density of 25.0 mg/cm² (surface density 25.0 gm/cm², mixture layer density 3.40 g/cm³, mixture layer thickness 73.5 μm, unit area initial charge capacity 4.49 mAh/cm²).

### Positive Electrode Preparation Example 2

“Preparation of Positive Electrode with Surface Density of 34.2 mg/cm²”

A positive electrode (surface density 34.2 gm/cm², mixture layer density 3.40 g/cm³, mixture layer thickness 58.4 μm, unit area initial charge capacity 6.14 mAh/cm²) was prepared completely in the same manner as in Positive Electrode Preparation Example 1, except that the gap of the bar coater was adjusted so that the coating amount (surface density) of the mixture was 34.2 mg/cm².

### Positive Electrode Preparation Example 3

“Preparation of Positive Electrode with Surface Density of 39.2 mg/cm²”

A positive electrode (surface density 39.2 gm/cm², mixture layer density 3.40 g/cm³, mixture layer thickness 68.0 μm, unit area initial charge capacity 7.04 mAh/cm²) was prepared completely in the same manner as in Positive Electrode Preparation Example 1, except that the gap of the bar coater was adjusted so that the coating amount (surface density) of the mixture was 39.2 mg/cm².

### “Battery Preparation”

### Example 25

The negative electrode described in Example 1 was cut into a square of 24 mm×24 mm with a tab, and the positive electrode described in Positive Electrode Preparation Example 1 was cut into a square of 22 mm×22 mm with a tab, each using a Thomson blade. A nickel tab lead was welded to the tab of the cut negative electrode, and an aluminum tab lead was welded to the tab of the cut positive electrode. Next, a separator (a microporous polyethylene membrane with a thickness of 20 microns) was cut into a rectangle of 28 mm×38 mm using a Thomson blade. The positive electrode and the negative electrode were placed to face each other with the separator interposed therebetween, and packaged in a laminated film. The tabs were fixed by thermocompression bonding. Then, 300 μL of an electrolyte (1.0 M LiPF6 ethylene carbonate/dimethyl carbonate/methyl ethyl carbonate=30/30/40 mixed solution (ratio by volume)+1% vinyl carbonate+5% fluoroethylene carbonate) was added and sealed by vacuum lamination to prepare a laminated secondary battery.

### (Initial Charge/Discharge (Chemical Conversion Process))

The secondary battery prepared as described above was sandwiched between two GORE hyper sheets and two acrylic plates thereon and fixed with two double clips such that a constant pressure was uniformly applied to the electrode sections. This was attached to a charger/discharger, left at 25° C. for 3 hours, and then charged/discharged once at a charge/discharge rate of 0.1 C. The initial charge/discharge efficiency at this time was 84.6%.

### (Electrode Expansion Measurement)

After the initial charge/discharge, the secondary battery was held at 45° C. and charged once at 0.5 C. The secondary battery was disassembled in a dry room, and the fully charged negative electrode was removed. After washing with dimethyl carbonate and natural drying, the electrode thickness was measured with a micrometer, and the thickness of the mixture layer was obtained by subtracting the thickness of the current collector. The electrode expansion rate was calculated and the result was 17.5%, where the thickness of the electrode mixture layer before charge was 100.

### (45° C. Cycle Characteristics)

After the initial charge/discharge, the temperature of the secondary battery prepared above was held at 45° C., and charge/discharge was repeated 100 times at 0.5 C. The discharge capacity retention rate after 100 cycles was 91.8% when the initial 0.5 C discharge capacity was 100%.

### (−10° C. Cycle Characteristics)

After the initial charge/discharge, the temperature of the secondary battery prepared above was held at −10° C., and charge/discharge was repeated 100 times at 0.5 C. The discharge capacity retention rate after 50 cycles was 84.9% when the initial 0.5 C discharge capacity was 100%.

### Example 26

The operation was conducted completely in the same manner as in Example 25, except that the negative electrode described in Example 2 was used. The resulting secondary battery had an initial charge/discharge capacity of 85.0%, an electrode expansion rate of 16.3%, a discharge capacity retention rate of 93.2% after 100 cycles at 45° C. and 0.5 C, and a discharge capacity retention rate of 85.6% after 50 cycles at −10° C. and 0.5 C.

### Example 27

The operation was conducted completely in the same manner as in Example 25, except that the negative electrode described in Example 3 was used. The resulting secondary battery had an initial charge/discharge capacity of 84.9%, an electrode expansion rate of 16.6%, a discharge capacity retention rate of 93.3% after 100 cycles at 45° C. and 0.5 C, and a discharge capacity retention rate of 85.5% after 50 cycles at −10° C. and 0.5 C.

### Example 28

The operation was conducted completely in the same manner as in Example 25, except that the negative electrode described in Example 4 was used. The resulting secondary battery had an initial charge/discharge capacity of 84.8%, an electrode expansion rate of 16.5%, a discharge capacity retention rate of 91.7% after 100 cycles at 45° C. and 0.5 C, and a discharge capacity retention rate of 84.8% after 50 cycles at −10° C. and 0.5 C.

### Example 29

The operation was conducted completely in the same manner as in Example 25, except that the negative electrode described in Example 5 was used. The resulting secondary battery had an initial charge/discharge capacity of 85.0%, an electrode expansion rate of 17.0%, a discharge capacity retention rate of 91.5% after 100 cycles at 45° C. and 0.5 C, and a discharge capacity retention rate of 84.6% after 50 cycles at −10° C. and 0.5 C.

### Example 30

The operation was conducted completely in the same manner as in Example 25, except that the negative electrode described in Example 6 was used. The resulting secondary battery had an initial charge/discharge capacity of 85.0%, an electrode expansion rate of 16.8%, a discharge capacity retention rate of 92.1% after 100 cycles at 45° C. and 0.5 C, and a discharge capacity retention rate of 85.0% after 50 cycles at −10° C. and 0.5 C.

### Example 31

The operation was conducted completely in the same manner as in Example 25, except that the negative electrode described in Example 7 was used. The resulting secondary battery had an initial charge/discharge capacity of 84.9%, an electrode expansion rate of 16.4%, a discharge capacity retention rate of 91.8% after 100 cycles at 45° C. and 0.5 C, and a discharge capacity retention rate of 85.2% after 50 cycles at −10° C. and 0.5 C.

### Example 32

The operation was conducted completely in the same manner as in Example 25, except that the negative electrode described in Example 8 was used. The resulting secondary battery had an initial charge/discharge capacity of 84.8%, an electrode expansion rate of 16.7%, a discharge capacity retention rate of 91.5% after 100 cycles at 45° C. and 0.5 C, and a discharge capacity retention rate of 84.9% after 50 cycles at −10° C. and 0.5 C.

### Example 33

The operation was conducted completely in the same manner as in Example 25, except that the negative electrode described in Example 9 was used. The resulting secondary battery had an initial charge/discharge capacity of 84.8%, an electrode expansion rate of 16.4%, a discharge capacity retention rate of 91.7% after 100 cycles at 45° C. and 0.5 C, and a discharge capacity retention rate of 85.0% after 50 cycles at −10° C. and 0.5 C.

### Example 34

The operation was conducted completely in the same manner as in Example 25, except that the negative electrode described in Example 10 was used. The resulting secondary battery had an initial charge/discharge capacity of 84.9%, an electrode expansion rate of 16.3%, a discharge capacity retention rate of 91.5% after 100 cycles at 45° C. and 0.5 C, and a discharge capacity retention rate of 83.9% after 50 cycles at −10° C. and 0.5 C.

### Example 35

The operation was conducted completely in the same manner as in Example 25, except that the negative electrode described in Example 11 was used. The resulting secondary battery had an initial charge/discharge capacity of 84.8%, an electrode expansion rate of 16.5%, a discharge capacity retention rate of 91.7% after 100 cycles at 45° C. and 0.5 C, and a discharge capacity retention rate of 84.5% after 50 cycles at −10° C. and 0.5 C.

### Example 36

The operation was conducted completely in the same manner as in Example 25, except that the negative electrode described in Example 12 was used. The resulting secondary battery had an initial charge/discharge capacity of 84.9%, an electrode expansion rate of 16.6%, a discharge capacity retention rate of 91.8% after 100 cycles at 45° C. and 0.5 C, and a discharge capacity retention rate of 85.2% after 50 cycles at −10° C. and 0.5 C.

### Example 37

The operation was conducted completely in the same manner as in Example 25, except that the negative electrode described in Example 13 was used. The resulting secondary battery had an initial charge/discharge capacity of 84.9%, an electrode expansion rate of 16.3%, a discharge capacity retention rate of 91.4% after 100 cycles at 45° C. and 0.5 C, and a discharge capacity retention rate of 84.7% after 50 cycles at −10° C. and 0.5 C.

### Example 38

The operation was conducted completely in the same manner as in Example 25, except that the negative electrode described in Example 14 was used. The resulting secondary battery had an initial charge/discharge capacity of 84.9%, an electrode expansion rate of 16.4%, a discharge capacity retention rate of 91.8% after 50 cycles at 45° C. and 0.5 C, and a discharge capacity retention rate of 84.5% after 50 cycles at −10° C. and 0.5 C.

### Example 39

The operation was conducted completely in the same manner as in Example 25, except that the negative electrode described in Example 15 was used. The resulting secondary battery had an initial charge/discharge capacity of 86.2%, an electrode expansion rate of 16.7%, a discharge capacity retention rate of 92.1% after 100 cycles at 45° C. and 0.5 C, and a discharge capacity retention rate of 85.4% after 50 cycles at −10° C. and 0.5 C.

### Example 40

The operation was conducted completely in the same manner as in Example 25, except that the negative electrode described in Example 16 was used. The resulting secondary battery had an initial charge/discharge capacity of 85.1%, an electrode expansion rate of 16.5%, a discharge capacity retention rate of 92.2% after 100 cycles at 45° C. and 0.5 C, and a discharge capacity retention rate of 85.5% after 50 cycles at −10° C. and 0.5 C.

### Example 41

The operation was conducted completely in the same manner as in Example 25, except that the negative electrode described in Example 17 was used. The resulting secondary battery had an initial charge/discharge capacity of 84.9%, an electrode expansion rate of 16.9%, a discharge capacity retention rate of 91.0% after 50 cycles at 45° C. and 0.5 C, and a discharge capacity retention rate of 84.4% after 50 cycles at −10° C. and 0.5 C.

### Example 42

The operation was conducted completely in the same manner as in Example 25, except that the negative electrode described in Example 18 was used. The resulting secondary battery had an initial charge/discharge capacity of 84.2%, an electrode expansion rate of 18.2%, a discharge capacity retention rate of 92.4% after 100 cycles at 45° C. and 0.5 C, and a discharge capacity retention rate of 85.7% after 50 cycles at −10° C. and 0.5 C.

### Example 43

The operation was conducted completely in the same manner as in Example 25, except that the negative electrode described in Example 19 was used. The resulting secondary battery had an initial charge/discharge capacity of 84.9%, an electrode expansion rate of 16.8%, a discharge capacity retention rate of 93.1% after 100 cycles at 45° C. and 0.5 C, and a discharge capacity retention rate of 86.3% after 50 cycles at −10° C. and 0.5 C.

### Example 44

The operation was conducted completely in the same manner as in Example 25, except that the negative electrode described in Example 20 was used. The resulting secondary battery had an initial charge/discharge capacity of 84.8%, an electrode expansion rate of 17.2%, a discharge capacity retention rate of 90.1% after 100 cycles at 45° C. and 0.5 C, and a discharge capacity retention rate of 83.5% after 50 cycles at −10° C. and 0.5 C.

### Example 45

The operation was conducted completely in the same manner as in Example 25, except that the negative electrode described in Example 21 and the positive electrode described in Positive Electrode Preparation Example 2 were used. The resulting secondary battery had an initial charge/discharge capacity of 84.0%, an electrode expansion rate of 19.6%, a discharge capacity retention rate of 88.3% after 100 cycles at 45° C. and 0.5 C, and a discharge capacity retention rate of 81.9% after 50 cycles at −10° C. and 0.5 C.

### Example 46

The operation was conducted completely in the same manner as in Example 25, except that the negative electrode described in Example 22 and the positive electrode described in Positive Electrode Preparation Example 5 were used. The resulting secondary battery had an initial charge/discharge capacity of 83.9%, an electrode expansion rate of 20.1%, a discharge capacity retention rate of 84.2% after 100 cycles at 45° C. and 0.5 C, and a discharge capacity retention rate of 78.1% after 50 cycles at −10° C. and 0.5 C.

### Example 47

The operation was conducted completely in the same manner as in Example 25, except that the negative electrode described in Example 23 and the positive electrode described in Positive Electrode Preparation Example 3 were used. The resulting secondary battery had an initial charge/discharge capacity of 83.2%, an electrode expansion rate of 25.5%, a discharge capacity retention rate of 88.5% after 100 cycles at 45° C. and 0.5 C, and a discharge capacity retention rate of 82.0% after 50 cycles at −10° C. and 0.5 C.

### Example 48

The operation was conducted completely in the same manner as in Example 25, except that the negative electrode described in Example 24 and the positive electrode described in Positive Electrode Preparation Example 4 were used. The resulting secondary battery had an initial charge/discharge capacity of 82.9%, an electrode expansion rate of 30.0%, a discharge capacity retention rate of 86.5% after 100 cycles at 45° C. and 0.5 C, and a discharge capacity retention rate of 80.2% after 50 cycles at −10° C. and 0.5 C.

### Comparative Example 18

The operation was conducted completely in the same manner as in Example 25, except that the negative electrode described in Comparative Example 1 was used. The resulting secondary battery had an initial charge/discharge capacity of 84.5%, an electrode expansion rate of 20.0%, a discharge capacity retention rate of 91.0% after 100 cycles at 45° C. and 0.5 C, and a discharge capacity retention rate of 64.8% after 50 cycles at −10° C. and 0.5 C.

### Comparative Example 19

The operation was conducted completely in the same manner as in Example 25, except that the negative electrode described in Comparative Example 2 was used. The resulting secondary battery had an initial charge/discharge capacity of 84.2%, an electrode expansion rate of 15.3%, a discharge capacity retention rate of 88.0% after 100 cycles at 45° C. and 0.5 C, and a discharge capacity retention rate of 62.5% after 50 cycles at −10° C. and 0.5 C.

### Comparative Example 20

The operation was conducted completely in the same manner as in Example 25, except that the negative electrode described in Comparative Example 3 was used. The resulting secondary battery had an initial charge/discharge capacity of 84.3%, an electrode expansion rate of 19.0%, a discharge capacity retention rate of 88.4% after 100 cycles at 45° C. and 0.5 C, and a discharge capacity retention rate of 63.0% after 50 cycles at −10° C. and 0.5 C.

### Comparative Example 21

The operation was conducted completely in the same manner as in Example 25, except that the negative electrode described in Comparative Example 4 was used. The resulting secondary battery had an initial charge/discharge capacity of 84.8%, an electrode expansion rate of 18.0%, a discharge capacity retention rate of 89.0% after 100 cycles at 45° C. and 0.5 C, and a discharge capacity retention rate of 63.4% after 50 cycles at −10° C. and 0.5 C.

### Comparative Example 22

The operation was conducted completely in the same manner as in Example 25, except that the negative electrode described in Comparative Example 5 was used. The resulting secondary battery had an initial charge/discharge capacity of 84.3%, an electrode expansion rate of 22.0%, a discharge capacity retention rate of 85.4% after 100 cycles at 45° C. and 0.5 C, and a discharge capacity retention rate of 63.8% after 50 cycles at −10° C. and 0.5 C.

### Comparative Example 23

The operation was conducted completely in the same manner as in Example 25, except that the negative electrode described in Comparative Example 6 was used. The resulting secondary battery had an initial charge/discharge capacity of 84.9%, an electrode expansion rate of 17.2%, a discharge capacity retention rate of 90.2% after 100 cycles at 45° C. and 0.5 C, and a discharge capacity retention rate of 64.6% after 50 cycles at −10° C. and 0.5 C.

### Comparative Example 24

The operation was conducted completely in the same manner as in Example 25, except that the negative electrode described in Comparative Example 7 was used. The resulting secondary battery had an initial charge/discharge capacity of 84.7%, an electrode expansion rate of 25.1%, a discharge capacity retention rate of 87.0% after 100 cycles at 45° C. and 0.5 C, and a discharge capacity retention rate of 63.3% after 50 cycles at −10° C. and 0.5 C.

### Comparative Example 25

The operation was conducted completely in the same manner as in Example 25, except that the negative electrode described in Comparative Example 8 was used. The resulting secondary battery had an initial charge/discharge capacity of 84.6%, an electrode expansion rate of 18.1%, a discharge capacity retention rate of 88.0% after 100 cycles at 45° C. and 0.5 C, and a discharge capacity retention rate of 62.9% after 50 cycles at −10° C. and 0.5 C.

### Comparative Example 26

The operation was conducted completely in the same manner as in Example 25, except that the negative electrode described in Comparative Example 9 was used. The resulting secondary battery had an initial charge/discharge capacity of 84.3%, an electrode expansion rate of 20.1%, a discharge capacity retention rate of 86.5% after 100 cycles at 45° C. and 0.5 C, and a discharge capacity retention rate of 64.4% after 50 cycles at −10° C. and 0.5 C.

### Comparative Example 27

The operation was conducted completely in the same manner as in Example 25, except that the negative electrode described in Comparative Example 10 was used. The resulting secondary battery had an initial charge/discharge capacity of 84.6%, an electrode expansion rate of 19.8%, a discharge capacity retention rate of 89.6% after 100 cycles at 45° C. and 0.5 C, and a discharge capacity retention rate of 64.4% after 50 cycles at −10° C. and 0.5 C.

### Comparative Example 28

The operation was conducted completely in the same manner as in Example 25, except that the negative electrode described in Comparative Example 11 was used. The resulting secondary battery had an initial charge/discharge capacity of 84.3%, an electrode expansion rate of 22.0%, a discharge capacity retention rate of 88.3% after 100 cycles at 45° C. and 0.5 C, and a discharge capacity retention rate of 63.8% after 50 cycles at −10° C. and 0.5 C.

### Comparative Example 29

The operation was conducted completely in the same manner as in Example 25, except that the negative electrode described in Comparative Example 12 was used. The resulting secondary battery had an initial charge/discharge capacity of 84.8%, an electrode expansion rate of 19.3%, a discharge capacity retention rate of 92.3% after 100 cycles at 45° C. and 0.5 C, and a discharge capacity retention rate of 69.7% after 50 cycles at −10° C. and 0.5 C.

### Comparative Example 30

The operation was conducted completely in the same manner as in Example 25, except that the negative electrode described in Comparative Example 13 was used. The resulting secondary battery had an initial charge/discharge capacity of 84.8%, an electrode expansion rate of 21.5%, a discharge capacity retention rate of 89.2% after 100 cycles at 45° C. and 0.5 C, and a discharge capacity retention rate of 67.4% after 50 cycles at −10° C. and 0.5 C.

### Comparative Example 31

The operation was conducted completely in the same manner as in Example 25, except that the negative electrode described in Comparative Example 14 was used. The resulting secondary battery had an initial charge/discharge capacity of 84.1%, an electrode expansion rate of 23.5%, a discharge capacity retention rate of 86.1% after 100 cycles at 45° C. and 0.5 C, and a discharge capacity retention rate of 65.1% after 50 cycles at −10° C. and 0.5 C.

### Comparative Example 32

The operation was conducted completely in the same manner as in Example 25, except that the negative electrode described in Comparative Example 15 was used. The resulting secondary battery had an initial charge/discharge capacity of 84.0%, an electrode expansion rate of 24.3%, a discharge capacity retention rate of 82.3% after 100 cycles at 45° C. and 0.5 C, and a discharge capacity retention rate of 62.2% after 50 cycles at −10° C. and 0.5 C.

### Comparative Example 33

The operation was conducted completely in the same manner as in Example 25, except that the negative electrode described in Comparative Example 16 was used. The resulting secondary battery had an initial charge/discharge capacity of 86.0%, an electrode expansion rate of 30.2%, a discharge capacity retention rate of 82.3% after 100 cycles at 45° C. and 0.5 C, and a discharge capacity retention rate of 65.0% after 50 cycles at −10° C. and 0.5 C.

### Comparative Example 34

The operation was conducted completely in the same manner as in Example 25, except that the negative electrode described in Comparative Example 17 was used. The resulting secondary battery had an initial charge/discharge capacity of 82.8%, an electrode expansion rate of 35.4%, a discharge capacity retention rate of 83.9% after 100 cycles at 45° C. and 0.5 C, and a discharge capacity retention rate of 63.4% after 50 cycles at −10° C. and 0.5 C.

Data on the above synthesis examples, the negative electrode slurry preparation examples, the positive electrode preparation examples, the negative electrodes prepared in Examples 1 to 24 and Comparative Examples 1 to 17, and the batteries prepared in Examples 25 to 48 and Comparative Examples 18 to 34 are summarized in Tables 3 and 4.

TABLE 3

| | | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|
| | | 1 | 2 | 3 | 4 | 5 | 6 | 7 | 8 | 9 | 10 | 11 | 12 |
| Battery | | Ex. 25 | Ex. 26 | Ex. 27 | Ex. 28 | Ex. 29 | Ex. 30 | Ex. 31 | Ex. 32 | Ex. 33 | Ex. 34 | Ex. 35 | Ex. 36 |
| Positive | | Positive | Positive | Positive | Positive | Positive | Positive | Positive | Positive | Positive | Positive | Positive | Positive |
| electrode | | elec- | elec- | elec- | elec- | elec- | elec- | elec- | elec- | elec- | elec- | elec- | elec- |
| | | trode | trode | trode | trode | trode | trode | trode | trode | trode | trode | trode | trode |
| | | pre- | pre- | pre- | pre- | pre- | pre- | pre- | pre- | pre- | pre- | pre- | pre- |
| | | paration | paration | paration | paration | paration | paration | paration | paration | paration | paration | paration | paration |
| | | ex. 1 | ex. 1 | ex. 1 | ex. 1 | ex. 1 | ex. 1 | ex. 1 | ex. 1 | ex. 1 | ex. 1 | ex. 1 | ex. 1 |
| Negative | | Ex. 1 | Ex. 2 | Ex. 3 | Ex. 4 | Ex. 5 | Ex. 6 | Ex. 7 | Ex. 8 | Ex. 9 | Ex. 10 | Ex. 11 | Ex. 12 |
| electrode | | | | | | | | | | | | | |
| Negative | | Slurry | Slurry | Slurry | Slurry | Slurry | Slurry | Slurry | Slurry | Slurry | Slurry | Slurry | Slurry |
| electrode | | pre- | pre- | pre- | pre- | pre- | pre- | pre- | pre- | pre- | pre- | pre- | pre- |
| mixture slurry | | paration | paration | paration | paration | paration | paration | paration | paration | paration | paration | paration | paration |
| | | Ex. 1 | Ex. 2 | Ex. 3 | Ex. 4 | Ex. 5 | Ex. 6 | Ex. 7 | Ex. 8 | Ex. 9 | Ex. 10 | Ex. 11 | Ex. 12 |
| Binder | Water- | 1.50 | 1.50 | 1.50 | 1.50 | 1.50 | 1.50 | 1.50 | 1.50 | 1.50 | 1.50 | 1.50 | 1.50 |
| resin | soluble | | | | | | | | | | | | |
| content | resin | | | | | | | | | | | | |
| in | (X) (%) | | | | | | | | | | | | |
| negative | Aqueous | 1.50 | 1.50 | 1.50 | 1.50 | 1.50 | 1.50 | 1.50 | 1.50 | 1.50 | 1.50 | 1.50 | 1.50 |
| electrode | latex | | | | | | | | | | | | |
| | rein | | | | | | | | | | | | |
| | (Y) (%) | | | | | | | | | | | | |
| Active | Graphite | 96.0 | 96.0 | 96.0 | 96.0 | 96.0 | 96.0 | 96.0 | 96.0 | 96.0 | 96.0 | 96.0 | 96.0 |
| material | (%) | | | | | | | | | | | | |
| content | SiO (%) | 0.0 | 0.0 | 0.0 | 0.0 | 0.0 | 0.0 | 0.0 | 0.0 | 0.0 | 0.0 | 0.0 | 0.0 |
| in | | | | | | | | | | | | | |
| negative | | | | | | | | | | | | | |
| electrode | | | | | | | | | | | | | |
| Con- | Acetylene | 1.0 | 1.0 | 1.0 | 1.0 | 1.0 | 1.0 | 1.0 | 1.0 | 1.0 | 1.0 | 1.0 | 1.0 |
| ductivity | black | | | | | | | | | | | | |
| aid | (%) | | | | | | | | | | | | |
| content | | | | | | | | | | | | | |
| in | | | | | | | | | | | | | |
| negative | | | | | | | | | | | | | |
| electrode | | | | | | | | | | | | | |
| Binder | PVDF | 3.0 | 3.0 | 3.0 | 3.0 | 3.0 | 3.0 | 3.0 | 3.0 | 3.0 | 3.0 | 3.0 | 3.0 |
| resin | (%) | | | | | | | | | | | | |
| content | | | | | | | | | | | | | |
| in | | | | | | | | | | | | | |
| positive | | | | | | | | | | | | | |
| electrode | | | | | | | | | | | | | |
| Active | Positive | 96.0 | 96.0 | 96.0 | 96.0 | 96.0 | 96.0 | 96.0 | 96.0 | 96.0 | 96.0 | 96.0 | 96.0 |
| material | electrode | | | | | | | | | | | | |
| content | material | | | | | | | | | | | | |
| in | (%) | | | | | | | | | | | | |
| positive | | | | | | | | | | | | | |
| electrode | | | | | | | | | | | | | |
| Con- | Acetylene | 1.0 | 1.0 | 1.0 | 1.0 | 1.0 | 1.0 | 1.0 | 1.0 | 1.0 | 1.0 | 1.0 | 1.0 |
| ductivity | black | | | | | | | | | | | | |
| aid | (%) | | | | | | | | | | | | |
| content | | | | | | | | | | | | | |
| in | | | | | | | | | | | | | |
| positive | | | | | | | | | | | | | |
| electrode | | | | | | | | | | | | | |
| Electrode | Negative | 13.2 | 13.2 | 13.2 | 13.2 | 13.2 | 13.2 | 13.2 | 13.2 | 13.2 | 13.2 | 13.2 | 13.2 |
| design | electrode | | | | | | | | | | | | |
| | surface | | | | | | | | | | | | |
| | density | | | | | | | | | | | | |
| | (mg/cm²) | | | | | | | | | | | | |
| | Negative | 1.65 | 1.65 | 1.65 | 1.65 | 1.65 | 1.65 | 1.65 | 1.65 | 1.65 | 1.65 | 1.65 | 1.65 |
| | electrode | | | | | | | | | | | | |
| | mixture | | | | | | | | | | | | |
| | layer | | | | | | | | | | | | |
| | density | | | | | | | | | | | | |
| | (mg/cm³) | | | | | | | | | | | | |
| | Negative | 80.0 | 80.0 | 80.0 | 80.0 | 80.0 | 80.0 | 80.0 | 80.0 | 80.0 | 80.0 | 80.0 | 80.0 |
| | electrode | | | | | | | | | | | | |
| | mixture | | | | | | | | | | | | |
| | layer | | | | | | | | | | | | |
| | thickness | | | | | | | | | | | | |
| | (μm) | | | | | | | | | | | | |
| | Negative | 4.97 | 4.97 | 4.97 | 4.97 | 4.97 | 4.97 | 4.97 | 4.97 | 4.97 | 4.97 | 4.97 | 4.97 |
| | electrode | | | | | | | | | | | | |
| | unit | | | | | | | | | | | | |
| | area | | | | | | | | | | | | |
| | initial | | | | | | | | | | | | |
| | charge | | | | | | | | | | | | |
| | capacity | | | | | | | | | | | | |
| | (mAh/cm²) | | | | | | | | | | | | |
| | Positive | 25.0 | 25.0 | 25.0 | 25.0 | 25.0 | 25.0 | 25.0 | 25.0 | 25.0 | 25.0 | 25.0 | 25.0 |
| | electrode | | | | | | | | | | | | |
| | surface | | | | | | | | | | | | |
| | density | | | | | | | | | | | | |
| | (mg/cm²) | | | | | | | | | | | | |
| | Positive | 3.40 | 3.40 | 3.40 | 3.40 | 3.40 | 3.40 | 3.40 | 3.40 | 3.40 | 3.40 | 3.40 | 3.40 |
| | electrode | | | | | | | | | | | | |
| | mixture | | | | | | | | | | | | |
| | layer | | | | | | | | | | | | |
| | density | | | | | | | | | | | | |
| | (mg/cm³) | | | | | | | | | | | | |
| | Positive | 73.5 | 73.5 | 73.5 | 73.5 | 73.5 | 73.5 | 73.5 | 73.5 | 73.5 | 73.5 | 73.5 | 73.5 |
| | electrode | | | | | | | | | | | | |
| | mixture | | | | | | | | | | | | |
| | layer | | | | | | | | | | | | |
| | thickness | | | | | | | | | | | | |
| | (μm) | | | | | | | | | | | | |
| | Positive | 4.49 | 4.49 | 4.49 | 4.49 | 4.49 | 4.49 | 4.49 | 4.49 | 4.49 | 4.49 | 4.49 | 4.49 |
| | electrode | | | | | | | | | | | | |
| | unit | | | | | | | | | | | | |
| | area | | | | | | | | | | | | |
| | initial | | | | | | | | | | | | |
| | charge | | | | | | | | | | | | |
| | capacity | | | | | | | | | | | | |
| | (mAh/cm²) | | | | | | | | | | | | |
| | Positive/ | 1.11 | 1.11 | 1.11 | 1.11 | 1.11 | 1.11 | 1.11 | 1.11 | 1.11 | 1.11 | 1.11 | 1.11 |
| | negative | | | | | | | | | | | | |
| | electrode | | | | | | | | | | | | |
| | capacity | | | | | | | | | | | | |
| | ratio | | | | | | | | | | | | |
| | (N/P | | | | | | | | | | | | |
| | ratio)) | | | | | | | | | | | | |
| Eval- | Negative | 34.5 | 31.5 | 27.8 | 28.9 | 24.5 | 30.7 | 28.4 | 29.1 | 30.5 | 28.6 | 28.4 | 30.1 |
| uation | electrode | | | | | | | | | | | | |
| result | peel | | | | | | | | | | | | |
| | strength | | | | | | | | | | | | |
| | (N/m) | | | | | | | | | | | | |
| | Negative | No | No | No | No | No | No | No | No | No | No | No | No |
| | electrode | cracking | cracking | cracking | cracking | cracking | cracking | cracking | cracking | cracking | cracking | cracking | cracking |
| | Ø5 | | | | | | | | | | | | |
| | bending | | | | | | | | | | | | |
| | cracking | | | | | | | | | | | | |
| | resistance | | | | | | | | | | | | |
| | Initial | 84.6 | 85.0 | 84.9 | 84.8 | 85 | 85 | 84.9 | 84.8 | 84.8 | 84.9 | 84.8 | 84.9 |
| | charge/ | | | | | | | | | | | | |
| | discharge | | | | | | | | | | | | |
| | efficiency | | | | | | | | | | | | |
| | (ICE) | | | | | | | | | | | | |
| | (%) | | | | | | | | | | | | |
| | Electrode | 17.5 | 16.3 | 16.6 | 16.5 | 17.0 | 16.8 | 16.4 | 16.7 | 16.4 | 16.3 | 16.5 | 16.6 |
| | expansion | | | | | | | | | | | | |
| | rate | | | | | | | | | | | | |
| | (%) | | | | | | | | | | | | |
| | Capacity | 91.8 | 93.2 | 93.3 | 91.7 | 91.5 | 92.1 | 91.8 | 91.5 | 91.7 | 91.5 | 91.7 | 91.8 |
| | retention | | | | | | | | | | | | |
| | rate | | | | | | | | | | | | |
| | (@45° C., | | | | | | | | | | | | |
| | 0.5 C | | | | | | | | | | | | |
| | 0.5 C, | | | | | | | | | | | | |
| | after | | | | | | | | | | | | |
| | 100 | | | | | | | | | | | | |
| | cycles) | | | | | | | | | | | | |
| | (%) | | | | | | | | | | | | |
| | Capacity | 84.9 | 85.6 | 85.5 | 84.8 | 84.6 | 85.0 | 85.2 | 84.9 | 85.0 | 83.9 | 84.5 | 85.2 |
| | retention | | | | | | | | | | | | |
| | rate | | | | | | | | | | | | |
| | (@ | | | | | | | | | | | | |
| | −10° C., | | | | | | | | | | | | |
| | 0.5 C | | | | | | | | | | | | |
| | 0.5 C, | | | | | | | | | | | | |
| | after | | | | | | | | | | | | |
| | 50 | | | | | | | | | | | | |
| | cycles) | | | | | | | | | | | | |
| | (%) | | | | | | | | | | | | |

TABLE 4

| | | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|
| | | 13 | 14 | 15 | 16 | 17 | 18 | 19 | 20 | 21 | 22 | 23 | 24 |
| Battery | | Ex. | Ex. | Ex. | Ex. | Ex. | Ex. | Ex. | Ex. | Ex. | Ex. | Ex. | Ex. |
| | | 37 | 38 | 39 | 40 | 41 | 42 | 43 | 44 | 45 | 46 | 47 | 48 |
| Positive | | Positive | Positive | Positive | Positive | Positive | Positive | Positive | Positive | Positive | Positive | Positive | Positive |
| electrode | | elec- | elec- | elec- | elec- | elec- | elec- | elec- | elec- | elec- | elec- | elec- | elec- |
| | | trode | trode | trode | trode | trode | trode | trode | trode | trode | trode | trode | trode |
| | | pre- | pre- | pre- | pre- | pre- | pre- | pre- | pre- | pre- | pre- | pre- | pre- |
| | | paration | paration | paration | paration | paration | paration | paration | paration | paration | paration | paration | paration |
| | | ex. 1 | ex. 1 | ex. 1 | ex. 1 | ex. 1 | ex. 1 | ex. 1 | ex. 1 | ex. 2 | ex. 3 | ex. 1 | ex. 1 |
| Negative | | Ex. 13 | Ex. 14 | Ex. 15 | Ex. 16 | Ex. 17 | Ex. 18 | Ex. 19 | Ex. 20 | Ex. 21 | Ex. 22 | Ex. 23 | Ex. 24 |
| electrode | | | | | | | | | | | | | |
| Negative | | Slurry | Slurry | Slurry | Slurry | Slurry | Slurry | Slurry | Slurry | Slurry | Slurry | Slurry | Slurry |
| electrode | | pre- | pre- | pre- | pre- | pre- | pre- | pre- | pre- | pre- | pre- | pre- | pre- |
| mixture slurry | | paration | paration | paration | paration | paration | paration | paration | paration | paration | paration | paration | paration |
| | | Ex. 13 | Ex. 14 | Ex. 15 | Ex. 16 | Ex. 17 | Ex. 18 | ex. 6 | ex. 6 | ex. 6 | ex. 6 | ex. 19 | ex. 20 |
| Binder | Water- | 1.50 | 1.50 | 1.50 | 1.50 | 2.00 | 1.20 | 1.50 | 1.50 | 1.50 | 1.50 | 1.50 | 1.50 |
| resin | soluble | | | | | | | | | | | | |
| content | resin | | | | | | | | | | | | |
| in | (X) (%) | | | | | | | | | | | | |
| negative | Aqueous | 1.50 | 1.50 | 1.50 | 1.50 | 2.00 | 1.20 | 1.50 | 1.50 | 1.50 | 1.50 | 1.50 | 1.50 |
| electrode | latex | | | | | | | | | | | | |
| | rein | | | | | | | | | | | | |
| | (Y) (%) | | | | | | | | | | | | |
| Active | Graphite | 96.0 | 96.0 | 96.0 | 96.0 | 95.0 | 96.6 | 96.0 | 96.0 | 96.0 | 96.0 | 92.30 | 90.70 |
| material | (%) | | | | | | | | | | | | |
| content | SiO (%) | 0.0 | 0.0 | 0.0 | 0.0 | 0.0 | 0.0 | 0.0 | 0.0 | 0.0 | 0.0 | 3.70 | 5.30 |
| in | | | | | | | | | | | | | |
| negative | | | | | | | | | | | | | |
| electrode | | | | | | | | | | | | | |
| Con- | Acetylene | 1.0 | 1.0 | 1.0 | 1.0 | 1.0 | 1.0 | 1.0 | 1.0 | 1.0 | 1.0 | 1.00 | 1.00 |
| ductivity | black | | | | | | | | | | | | |
| aid | (%) | | | | | | | | | | | | |
| content | | | | | | | | | | | | | |
| in | | | | | | | | | | | | | |
| negative | | | | | | | | | | | | | |
| electrode | | | | | | | | | | | | | |
| Binder | PVDF | 3.0 | 3.0 | 3.0 | 3.0 | 3.0 | 3.0 | 3.0 | 3.0 | 3.0 | 3.0 | 3.0 | 3.0 |
| resin | (%) | | | | | | | | | | | | |
| content | | | | | | | | | | | | | |
| in | | | | | | | | | | | | | |
| positive | | | | | | | | | | | | | |
| electrode | | | | | | | | | | | | | |
| Active | Positive | 96.0 | 96.0 | 96.0 | 96.0 | 96.0 | 96.0 | 96.0 | 96.0 | 96.0 | 96.0 | 96.0 | 96.0 |
| material | electrode | | | | | | | | | | | | |
| content | material | | | | | | | | | | | | |
| in | (%) | | | | | | | | | | | | |
| positive | | | | | | | | | | | | | |
| electrode | | | | | | | | | | | | | |
| Con- | Acetylene | 1.0 | 1.0 | 1.0 | 1.0 | 1.0 | 1.0 | 1.0 | 1.0 | 1.0 | 1.0 | 1.0 | 1.0 |
| ductivity | black | | | | | | | | | | | | |
| aid | (%) | | | | | | | | | | | | |
| content | | | | | | | | | | | | | |
| in | | | | | | | | | | | | | |
| positive | | | | | | | | | | | | | |
| electrode | | | | | | | | | | | | | |
| Electrode | Negative | 13.2 | 13.2 | 13.2 | 13.2 | 13.2 | 13.2 | 13.2 | 13.2 | 18.2 | 20.7 | 11.3 | 10.7 |
| design | electrode | | | | | | | | | | | | |
| | surface | | | | | | | | | | | | |
| | density | | | | | | | | | | | | |
| | (mg/cm²) | | | | | | | | | | | | |
| | Negative | 1.65 | 1.65 | 1.65 | 1.65 | 1.65 | 1.65 | 1.40 | 1.70 | 1.65 | 1.65 | 1.65 | 1.65 |
| | electrode | | | | | | | | | | | | |
| | mixture | | | | | | | | | | | | |
| | layer | | | | | | | | | | | | |
| | density | | | | | | | | | | | | |
| | (mg/cm³) | | | | | | | | | | | | |
| | Negative | 80.0 | 80.0 | 80.0 | 80.0 | 80.0 | 80.0 | 94.3 | 75.4 | 110.0 | 125.0 | 68.5 | 64.8 |
| | electrode | | | | | | | | | | | | |
| | mixture | | | | | | | | | | | | |
| | layer | | | | | | | | | | | | |
| | thickness | | | | | | | | | | | | |
| | (μm) | | | | | | | | | | | | |
| | Negative | 4.97 | 4.97 | 4.97 | 4.97 | 4.89 | 4.97 | 4.97 | 4.97 | 6.81 | 7.75 | 4.94 | 4.98 |
| | electrode | | | | | | | | | | | | |
| | unit | | | | | | | | | | | | |
| | area | | | | | | | | | | | | |
| | initial | | | | | | | | | | | | |
| | charge | | | | | | | | | | | | |
| | capacity | | | | | | | | | | | | |
| | (mAh/cm²) | | | | | | | | | | | | |
| | Positive | 25.0 | 25.0 | 25.0 | 25.0 | 25.0 | 25.0 | 25.0 | 25.0 | 34.2 | 39.2 | 25.0 | 25.0 |
| | electrode | | | | | | | | | | | | |
| | surface | | | | | | | | | | | | |
| | density | | | | | | | | | | | | |
| | (mg/cm²) | | | | | | | | | | | | |
| | Positive | 3.40 | 3.40 | 3.40 | 3.40 | 3.40 | 3.40 | 3.40 | 3.40 | 3.40 | 3.40 | 3.40 | 3.40 |
| | electrode | | | | | | | | | | | | |
| | mixture | | | | | | | | | | | | |
| | layer | | | | | | | | | | | | |
| | density | | | | | | | | | | | | |
| | (mg/cm³) | | | | | | | | | | | | |
| | Positive | 73.5 | 73.5 | 73.5 | 73.5 | 73.5 | 73.5 | 73.5 | 73.5 | 73.5 | 73.5 | 73.5 | 73.5 |
| | electrode | | | | | | | | | | | | |
| | mixture | | | | | | | | | | | | |
| | layer | | | | | | | | | | | | |
| | thickness | | | | | | | | | | | | |
| | (μm) | | | | | | | | | | | | |
| | Positive | 4.49 | 4.49 | 4.49 | 4.49 | 4.49 | 4.49 | 4.49 | 4.49 | 6.14 | 7.04 | 4.49 | 4.49 |
| | electrode | | | | | | | | | | | | |
| | unit | | | | | | | | | | | | |
| | area | | | | | | | | | | | | |
| | initial | | | | | | | | | | | | |
| | charge | | | | | | | | | | | | |
| | capacity | | | | | | | | | | | | |
| | (mAh/cm²) | | | | | | | | | | | | |
| | Positive/ | 1.11 | 1.11 | 1.11 | 1.11 | 1.09 | 1.11 | 1.11 | 1.11 | 1.11 | 1.10 | 1.10 | 1.11 |
| | negative | | | | | | | | | | | | |
| | electrode | | | | | | | | | | | | |
| | capacity | | | | | | | | | | | | |
| | ratio | | | | | | | | | | | | |
| | (N/P | | | | | | | | | | | | |
| | ratio)) | | | | | | | | | | | | |
| Eval- | Negative | 32 | 29.8 | 29.5 | 34.6 | 56 | 16.2 | 29 | 35.2 | 30.1 | 25.5 | 32 | 34 |
| uation | electrode | | | | | | | | | | | | |
| result | peel | | | | | | | | | | | | |
| | strength | | | | | | | | | | | | |
| | (N/m) | | | | | | | | | | | | |
| | Negative | No | No | No | No | No | No | No | No | No | No | No | No |
| | electrode | cracking | cracking | cracking | cracking | cracking | cracking | cracking | cracking | cracking | cracking | cracking | cracking |
| | Ø5 | | | | | | | | | | | | |
| | bending | | | | | | | | | | | | |
| | cracking | | | | | | | | | | | | |
| | resistance | | | | | | | | | | | | |
| | Initial | 84.7 | 84.8 | 86.2 | 85.1 | 85 | 84.2 | 84.9 | 84.8 | 84 | 83.9 | 83.2 | 82.9 |
| | charge/ | | | | | | | | | | | | |
| | discharge | | | | | | | | | | | | |
| | efficiency | | | | | | | | | | | | |
| | (ICE) | | | | | | | | | | | | |
| | (%) | | | | | | | | | | | | |
| | Electrode | 16.3 | 16.4 | 16.7 | 16.5 | 16.9 | 18.2 | 16.8 | 17.2 | 19.6 | 20.1 | 25.5 | 30.0 |
| | expansion | | | | | | | | | | | | |
| | rate | | | | | | | | | | | | |
| | (%) | | | | | | | | | | | | |
| | Capacity | 91.4 | 91.8 | 92.1 | 92.2 | 91 | 92.4 | 93.1 | 90.1 | 88.3 | 84.2 | 88.5 | 86.5 |
| | retention | | | | | | | | | | | | |
| | rate | | | | | | | | | | | | |
| | (@45° C., | | | | | | | | | | | | |
| | 0.5 C | | | | | | | | | | | | |
| | 0.5 C, | | | | | | | | | | | | |
| | after | | | | | | | | | | | | |
| | 100 | | | | | | | | | | | | |
| | cycles) | | | | | | | | | | | | |
| | (%) | | | | | | | | | | | | |
| | Capacity | 84.7 | 84.5 | 85.4 | 85.5 | 84.4 | 85.7 | 86.3 | 83.5 | 81.9 | 78.1 | 82.0 | 80.2 |
| | retention | | | | | | | | | | | | |
| | rate | | | | | | | | | | | | |
| | (@ | | | | | | | | | | | | |
| | −10° C., | | | | | | | | | | | | |
| | 0.5 C | | | | | | | | | | | | |
| | 0.5 C, | | | | | | | | | | | | |
| | after | | | | | | | | | | | | |
| | 50 | | | | | | | | | | | | |
| | cycles) | | | | | | | | | | | | |
| | (%) | | | | | | | | | | | | |

TABLE 5

| | | Comp. | Comp. | Comp. | Comp. | Comp. | Comp. | Comp. | Comp. | Comp. | Comp. |
|---|---|---|---|---|---|---|---|---|---|---|---|
| | | Ex. | Ex. | Ex. | Ex. | Ex. | Ex. | Ex. | Ex. | Ex. | Ex. |
| | | 16 | 17 | 18 | 19 | 20 | 21 | 22 | 23 | 24 | 27 |
| Battery | | Comp. | Comp. | Comp. | Comp. | Comp. | Comp. | Comp. | Comp. | Comp. | Comp. |
| | | Ex. 18 | Ex. 19 | Ex. 20 | Ex. 21 | Ex. 22 | Ex. 23 | Ex. 24 | Ex. 25 | Ex. 26 | Ex. 27 |
| Positive | | Positive | Positive | Positive | Positive | Positive | Positive | Positive | Positive | Positive | Positive |
| electrode | | electrode | electrode | electrode | electrode | electrode | electrode | electrode | electrode | electrode | electrode |
| | | pre- | pre- | pre- | pre- | pre- | pre- | pre- | pre- | pre- | pre- |
| | | paration | paration | paration | paration | paration | paration | paration | paration | paration | paration |
| | | ex. 1 | ex. 1 | ex. 1 | ex. 1 | ex. 1 | ex. 1 | ex. 1 | ex. 1 | ex. 1 | ex. 1 |
| Negative | | Comp. | Comp. | Comp. | Comp. | Comp. | Comp. | Comp. | Comp. | Comp. | Comp. |
| electrode | | Ex. 1 | Ex. 2 | Ex. 3 | Ex. 4 | Ex. 5 | Ex. 6 | Ex. 7 | Ex. 8 | Ex. 9 | Ex. 10 |
| Negative | | Slurry | Slurry | Slurry | Slurry | Slurry | Slurry | Slurry | Slurry | Slurry | Slurry |
| electrode mixture | | pre- | pre- | pre- | pre- | pre- | pre- | pre- | pre- | pre- | pre- |
| slurry | | paration | paration | paration | paration | paration | paration | paration | paration | paration | paration |
| | | ex. 21 | ex. 22 | ex. 23 | ex. 24 | ex. 25 | ex. 26 | ex. 27 | ex. 28 | ex. 29 | ex. 30 |
| Binder | Water- | 1.50 | 3.00 | 1.50 | 1.50 | 1.50 | 1.50 | 1.50 | 1.50 | 1.50 | 2.00 |
| resin | soluble | | | | | | | | | | |
| content | resin (X) | | | | | | | | | | |
| in | (%) | | | | | | | | | | |
| negative | Aqueous | 1.50 | — | 1.50 | 1.50 | 1.50 | 1.50 | 1.50 | 1.50 | 1.50 | 2.00 |
| electrode | latex | | | | | | | | | | |
| | rein (Y) | | | | | | | | | | |
| | (%) | | | | | | | | | | |
| Active | Graphite | 96.00 | 96 | 96.00 | 96.00 | 96.00 | 96.00 | 96.00 | 96.00 | 96.00 | 95.00 |
| material | (%) | | | | | | | | | | |
| content | SiO (%) | 0.00 | 0 | 0.00 | 0.00 | 0.00 | 0.00 | 0.00 | 0.00 | 0.00 | 0.00 |
| in | | | | | | | | | | | |
| negative | | | | | | | | | | | |
| electrode | | | | | | | | | | | |
| Con- | Acetylene | 1.00 | 1 | 1.00 | 1.00 | 1.00 | 1.00 | 1.00 | 1.00 | 1.00 | 1.00 |
| ductivity | black | | | | | | | | | | |
| aid | (%) | | | | | | | | | | |
| content | | | | | | | | | | | |
| in | | | | | | | | | | | |
| negative | | | | | | | | | | | |
| electrode | | | | | | | | | | | |
| Binder | PVDF (%) | 3.0 | 3.0 | 3.0 | 3.0 | 3.0 | 3.0 | 3.0 | 3.0 | 3.0 | 3.0 |
| resin | | | | | | | | | | | |
| content | | | | | | | | | | | |
| in | | | | | | | | | | | |
| positive | | | | | | | | | | | |
| electrode | | | | | | | | | | | |
| Active | Positive | 96.0 | 96.0 | 96.0 | 96.0 | 96.0 | 96.0 | 96.0 | 96.0 | 96.0 | 96.0 |
| material | electrode | | | | | | | | | | |
| content | material | | | | | | | | | | |
| in | (%) | | | | | | | | | | |
| positive | | | | | | | | | | | |
| electrode | | | | | | | | | | | |
| Con- | Acetylene | 1.0 | 1.0 | 1.0 | 1.0 | 1.0 | 1.0 | 1.0 | 1.0 | 1.0 | 1.0 |
| ductivity | black | | | | | | | | | | |
| aid | (%) | | | | | | | | | | |
| content | | | | | | | | | | | |
| in | | | | | | | | | | | |
| positive | | | | | | | | | | | |
| electrode | | | | | | | | | | | |
| Electrode | Negative | 13.2 | 13.2 | 13.2 | 13.2 | 13.2 | 13.2 | 13.2 | 13.2 | 13.2 | 13.2 |
| design | electrode | | | | | | | | | | |
| | surface | | | | | | | | | | |
| | density | | | | | | | | | | |
| | (mg/cm²) | | | | | | | | | | |
| | Negative | 1.65 | 1.65 | 1.65 | 1.65 | 1.65 | 1.65 | 1.65 | 1.65 | 1.65 | 1.65 |
| | electrode | | | | | | | | | | |
| | mixture | | | | | | | | | | |
| | layer | | | | | | | | | | |
| | density | | | | | | | | | | |
| | (mg/cm³) | | | | | | | | | | |
| | Negative | 80.0 | 80.0 | 80.0 | 80.0 | 80.0 | 80.0 | 80.0 | 80.0 | 80.0 | 80.0 |
| | electrode | | | | | | | | | | |
| | mixture | | | | | | | | | | |
| | layer | | | | | | | | | | |
| | thicknes | | | | | | | | | | |
| | (μm) | | | | | | | | | | |
| | Negative | 4.97 | 4.97 | 4.97 | 4.97 | 4.97 | 4.97 | 4.97 | 4.97 | 4.97 | 4.89 |
| | electrode | | | | | | | | | | |
| | unit | | | | | | | | | | |
| | area | | | | | | | | | | |
| | initial | | | | | | | | | | |
| | charge | | | | | | | | | | |
| | capacity | | | | | | | | | | |
| | (mAh/cm²) | | | | | | | | | | |
| | Positive | 25.0 | 25.0 | 25.0 | 25.0 | 25.0 | 25.0 | 25.0 | 25.0 | 25.0 | 25.0 |
| | electrode | | | | | | | | | | |
| | surface | | | | | | | | | | |
| | density | | | | | | | | | | |
| | (mg/cm²) | | | | | | | | | | |
| | Positive | 3.40 | 3.40 | 3.40 | 3.40 | 3.40 | 3.40 | 3.40 | 3.40 | 3.40 | 3.40 |
| | electrode | | | | | | | | | | |
| | mixture | | | | | | | | | | |
| | layer | | | | | | | | | | |
| | density | | | | | | | | | | |
| | (mg/cm³) | | | | | | | | | | |
| | Positive | 73.5 | 73.5 | 73.5 | 73.5 | 73.5 | 73.5 | 73.5 | 73.5 | 73.5 | 73.5 |
| | electrode | | | | | | | | | | |
| | mixture | | | | | | | | | | |
| | layer | | | | | | | | | | |
| | thickness | | | | | | | | | | |
| | (μm) | | | | | | | | | | |
| | Positive | 4.49 | 4.49 | 4.49 | 4.49 | 4.49 | 4.49 | 4.49 | 4.49 | 4.49 | 4.49 |
| | electrode | | | | | | | | | | |
| | unit | | | | | | | | | | |
| | area | | | | | | | | | | |
| | initial | | | | | | | | | | |
| | charge | | | | | | | | | | |
| | capacity | | | | | | | | | | |
| | (mAh/cm²) | | | | | | | | | | |
| | Positive/ | 1.11 | 1.11 | 1.11 | 1.11 | 1.11 | 1.11 | 1.11 | 1.11 | 1.11 | 1.09 |
| | negative | | | | | | | | | | |
| | electrode | | | | | | | | | | |
| | capacity | | | | | | | | | | |
| | ratio | | | | | | | | | | |
| | (N/F | | | | | | | | | | |
| | ratio)) | | | | | | | | | | |
| Eval- | Negative | 16.8 | 38 | 14.8 | 17.4 | 14.5 | 18 | 15.2 | 14.5 | 16.4 | 25.2 |
| uation | electrode | | | | | | | | | | |
| result | peel | | | | | | | | | | |
| | strength | | | | | | | | | | |
| | (N/m) | | | | | | | | | | |
| | Negative | No | No | No | No | No | No | No | No | No | Nc |
| | electrode | cracking | cracking | cracking | cracking | cracking | cracking | cracking | cracking | cracking | cracking |
| | Ø5 | | | | | | | | | | |
| | bending | | | | | | | | | | |
| | cracking | | | | | | | | | | |
| | resistance | | | | | | | | | | |
| | Initial | 84.5 | 84.2 | 84.3 | 84.8 | 84.3 | 84.9 | 84.7 | 84.6 | 84.3 | 84.6 |
| | charge/ | | | | | | | | | | |
| | discharge | | | | | | | | | | |
| | efficiency | | | | | | | | | | |
| | (ICE) | | | | | | | | | | |
| | (%) | | | | | | | | | | |
| | Electrode | 20.0 | 15.3 | 19.0 | 18.0 | 22.0 | 17.2 | 25.1 | 18.1 | 20.1 | 19.8 |
| | expansion | | | | | | | | | | |
| | rate | | | | | | | | | | |
| | (%) | | | | | | | | | | |
| | Capacity | 91 | 88 | 88.4 | 89 | 85.4 | 90.2 | 87 | 88 | 86.5 | 89.6 |
| | retention | | | | | | | | | | |
| | rate | | | | | | | | | | |
| | (@45° C., | | | | | | | | | | |
| | 0.5 C | | | | | | | | | | |
| | 0.5 C, | | | | | | | | | | |
| | after 100 | | | | | | | | | | |
| | cycles) | | | | | | | | | | |
| | (%) | | | | | | | | | | |
| | Capacity | 64.8 | 62.5 | 63.0 | 63.4 | 63.8 | 64.6 | 63.3 | 62.9 | 64.4 | 64.4 |
| | retention | | | | | | | | | | |
| | rate | | | | | | | | | | |
| | (@−10° C., | | | | | | | | | | |
| | 0.5 C | | | | | | | | | | |
| | 0.5 C, | | | | | | | | | | |
| | after 50 | | | | | | | | | | |
| | cycles) | | | | | | | | | | |
| | (%) | | | | | | | | | | |

TABLE 6

| | | Comp. | Comp. | Comp. | Comp. | Comp. | Comp. | Comp. |
|---|---|---|---|---|---|---|---|---|
| | | Ex. 28 | Ex. 29 | Ex. 30 | Ex. 31 | Ex. 32 | Ex. 33 | Ex. 34 |
| Battery | | Comp. | Comp. | Comp. | Comp. | Comp. | Comp. | Comp. |
| | | Ex. 28 | Ex. 29 | Ex. 30 | Ex. 31 | Ex. 32 | Ex. 33 | Ex. 34 |
| Positive electrode | | Positive | Positive | Positive | Positive | Positive | Positive | Positive |
| | | electrode | electrode | electrode | electrode | electrode | electrode | electrode |
| | | pre- | pre- | pre- | pre- | pre- | pre- | pre- |
| | | paration | paration | paration | paration | paration | paration | paration |
| | | ex. 1 | ex. 1 | ex. 1 | ex. 2 | ex. 3 | ex. 1 | ex. 1 |
| Negative electrode | | Comp. | Comp. | Comp. | Comp. | Comp. | Comp. | Comp. |
| | | Ex. 11 | Ex. 12 | Ex. 13 | Ex. 14 | Ex. 15 | Ex. 16 | Ex. 17 |
| Negative electrode | | Slurry | Slurry | Slurry | Slurry | Slurry | Slurry | Slurry |
| mixture slurry | | pre- | pre- | pre- | pre- | pre- | pre- | pre- |
| | | paration | paration | paration | paration | paration | paration | paration |
| | | ex. 31 | ex. 21 | ex. 21 | ex. 21 | ex. 21 | ex. 32 | ex. 33 |
| Binder | Water- | 1.20 | 1.50 | 1.50 | 1.50 | 1.50 | 1.50 | 1.50 |
| resin | soluble resin | | | | | | | |
| content | (X) (%) | | | | | | | |
| in | Aqueous latex | 1.20 | 1.50 | 1.50 | 1.50 | 1.50 | 1.50 | 1.50 |
| negative | rein (Y) (%) | | | | | | | |
| electrode | | | | | | | | |
| Active | Graphite (%) | 96.60 | 96.00 | 96.00 | 96.00 | 96.00 | 92.30 | 90.70 |
| material | SiO (%) | 0.00 | 0.00 | 0.00 | 0.00 | 0.00 | 3.70 | 5.30 |
| content | | | | | | | | |
| in | | | | | | | | |
| negative | | | | | | | | |
| electrode | | | | | | | | |
| Con- | Acetylene | 1.00 | 1.00 | 1.00 | 1.00 | 1.00 | 1.00 | 1.00 |
| ductivity | black (%) | | | | | | | |
| aid | | | | | | | | |
| content | | | | | | | | |
| in | | | | | | | | |
| negative | | | | | | | | |
| electrode | | | | | | | | |
| Binder | PVDF (%) | 3.0 | 3.0 | 3.0 | 3.0 | 3.0 | 3.0 | 3.0 |
| resin | | | | | | | | |
| content | | | | | | | | |
| in | | | | | | | | |
| positive | | | | | | | | |
| electrode | | | | | | | | |
| Active | Positive | 96.0 | 96.0 | 96.0 | 96.0 | 96.0 | 96.0 | 96.0 |
| material | electrode | | | | | | | |
| content | material (%) | | | | | | | |
| in | | | | | | | | |
| positive | | | | | | | | |
| electrode | | | | | | | | |
| Con- | Acetylene | 1.0 | 1.0 | 1.0 | 1.0 | 1.0 | 1.0 | 1.0 |
| ductivity | black (%) | | | | | | | |
| aid | | | | | | | | |
| content | | | | | | | | |
| in | | | | | | | | |
| positive | | | | | | | | |
| electrode | | | | | | | | |
| Electrode | Negative | 13.2 | 13.2 | 13.2 | 18.2 | 20.7 | 11.3 | 10.7 |
| design | electrode | | | | | | | |
| | surface | | | | | | | |
| | density | | | | | | | |
| | (mg/cm²) | | | | | | | |
| | Negative | 1.65 | 1.40 | 1.70 | 1.65 | 1.65 | 1.65 | 1.65 |
| | electrode | | | | | | | |
| | mixture layer | | | | | | | |
| | density | | | | | | | |
| | (mg/cm³) | | | | | | | |
| | Negative | 80.0 | 94.3 | 75.4 | 110.0 | 125.0 | 68.5 | 64.8 |
| | electrode | | | | | | | |
| | mixture layer | | | | | | | |
| | thickness | | | | | | | |
| | (μm) | | | | | | | |
| | Negative | 4.97 | 4.97 | 4.97 | 6.81 | 7.75 | 4.94 | 4.98 |
| | electrode | | | | | | | |
| | unit area | | | | | | | |
| | initial | | | | | | | |
| | charge | | | | | | | |
| | capacity | | | | | | | |
| | (mAh/cm²) | | | | | | | |
| | Positive | 25.0 | 25.0 | 25.0 | 34.2 | 39.2 | 25.0 | 25.0 |
| | electrode | | | | | | | |
| | surface | | | | | | | |
| | density | | | | | | | |
| | (mg/cm²) | | | | | | | |
| | Positive | 3.40 | 3.40 | 3.40 | 3.40 | 3.40 | 3.40 | 3.40 |
| | electrode | | | | | | | |
| | mixture layer | | | | | | | |
| | density | | | | | | | |
| | (mg/cm³) | | | | | | | |
| | Positive | 73.5 | 73.5 | 73.5 | 58.4 | 68.0 | 73.5 | 73.5 |
| | electrode | | | | | | | |
| | mixture layer | | | | | | | |
| | thickness | | | | | | | |
| | (μm) | | | | | | | |
| | Positive | 4.49 | 4.49 | 4.49 | 6.14 | 7.04 | 4.49 | 4.49 |
| | electrode | | | | | | | |
| | unit area | | | | | | | |
| | initial | | | | | | | |
| | charge | | | | | | | |
| | capacity | | | | | | | |
| | (mAh/cm²) | | | | | | | |
| | Positive/ | 1.11 | 1.11 | 1.11 | 1.11 | 1.10 | 1.10 | 1.11 |
| | negative | | | | | | | |
| | electrode | | | | | | | |
| | capacity | | | | | | | |
| | ratio (N/P | | | | | | | |
| | ratio)) | | | | | | | |
| Eval- | Negative | 13.2 | 15.2 | 19.8 | 20 | 13.2 | 13.2 | 13.2 |
| uation | electrode | | | | | | | |
| result | peel strength | | | | | | | |
| | (N/m) | | | | | | | |
| | Negative | No | No | No | No | No | No | No |
| | electrode Ø5 | cracking | cracking | cracking | cracking | cracking | cracking | cracking |
| | bending | | | | | | | |
| | cracking | | | | | | | |
| | resistance | | | | | | | |
| | Initial | 84.3 | 84.8 | 84.8 | 84.1 | 84 | 83.3 | 82.8 |
| | charge/ | | | | | | | |
| | discharge | | | | | | | |
| | efficiency | | | | | | | |
| | (ICE) (%) | | | | | | | |
| | Electrode | 22.0 | 19.3 | 21.5 | 23.5 | 24.3 | 30.2 | 35.4 |
| | expansion | | | | | | | |
| | rate (%) | | | | | | | |
| | Capacity | 88.3 | 92.3 | 89.2 | 86.1 | 82.3 | 86 | 83.9 |
| | retention | | | | | | | |
| | rate (@45° C., | | | | | | | |
| | 0.5 C 0.5 C, | | | | | | | |
| | after 100 | | | | | | | |
| | cycles) (%) | | | | | | | |
| | Capacity | 63.8 | 69.7 | 67.4 | 65.1 | 62.2 | 65.0 | 63.4 |
| | retention | | | | | | | |
| | rate (@−10° C., | | | | | | | |
| | 0.5 C 0.5 C, | | | | | | | |
| | after 5 C | | | | | | | |
| | cycles) (%) | | | | | | | |

As demonstrated by Example 25, when the water-soluble resin (X) containing a copolymer of the hydroxyl group-containing monomer (a) and the acid group-containing monomer (b) as essential components according to the present invention and SBR are used as a binder, the peel strength, the capacity retention rate after 100 cycles at 45° C., and the capacity retention rate after 100 cycles at 0° C. are better than when CMC and SBR are used as demonstrated by Comparative Example 1. Further, as demonstrated by Examples 26 to 28, when the water-soluble resin (X) containing a copolymer of the hydroxyl group-containing monomer (a) and the acid group-containing monomer (b) as essential components and the latex resin (Y) according to the present invention are used as a binder, the peel strength, the capacity retention rate after 100 cycles at 45° C., and the capacity retention rate after 100 cycles at 0° C. are also better than in Comparative Example 1. Further, as demonstrated by Examples 29 to 38, when the water-soluble resin (X) further includes other monomer (c), the peel strength, the capacity retention rate after 100 cycles at 45° C., and the capacity retention rate after 100 cycles at 0° C. are also better than when CMC and SBR are used as demonstrated by Comparative Example 1. These results indicate that good electrode and battery properties can be achieved by using the water-soluble resin (X) containing a copolymer of the hydroxyl group-containing monomer (a) and the acid group-containing monomer (b) as essential components according to the present invention, or the resin in which the water-soluble resin (X) further contains other monomer (c), and the latex resin (Y) according to the present invention as a binder.

As demonstrated by Examples 38 to 40, even when the acid group-containing monomer (b) is an ammonium salt, a lithium salt, and a sodium salt, the peel strength, the capacity retention rate after 100 cycles at 45° C., and the capacity retention rate after 100 cycles at 0° C. are better. These results indicate that good electrode and battery properties can be achieved even when the acid group-containing monomer (b) is neutralized with a basic composition or a light metal hydroxide.

On the other hand, as demonstrated by Comparative Example 17, when only the water-soluble resin (X) containing a copolymer of the hydroxyl group-containing monomer (a) and the acid group-containing monomer (b) as essential components according to the present invention was used as a binder without using the aqueous latex (Y), the peel strength was greatly improved compared with when CMC and SBR are used as demonstrated by Comparative Example 1, but the capacity retention rate after 100 cycles at 45° C. and the capacity retention rate after 100 cycles at 0° C. were decreased. This indicates that better electrode and battery properties can be achieved in graphite-only negative electrodes when both the water-soluble resin (X) containing a copolymer of the hydroxyl group-containing monomer (a) and the acid group-containing monomer (b) as essential components and the aqueous latex (Y) according to the present invention are used simultaneously.

Further, as demonstrated by Comparative Example 18, when CMC and the aqueous latex (Y) according to the present invention were used, the peel strength, the capacity retention rate after 100 cycles at 45° C., and the capacity retention rate after 100 cycles at 0° C. were each decreased, compared with when CMC and SBR were used as demonstrated by Comparative Example 1. These results indicate that good electrode and battery properties can be achieved when the aqueous latex (Y) according to the present invention is used in combination with the water-soluble resin (X) containing a copolymer of the hydroxyl group-containing monomer (a) and the acid group-containing monomer (b) as essential components according to the present invention.

As demonstrated by Example 30, Example 43, Example 44, Comparative Example 16, Comparative Example 25, and Comparative Example 26, even when the electrode density of the negative electrode was varied in the range of 1.40 to 1.75 g/cm³, the peel strength, the capacity retention rate after 100 cycles at 45° C., and the capacity retention rate after 100 cycles at 0° C. in Example 30 (electrode density 1.50 g/cm³), Example 43 (electrode density 1.40 g/cm³), and Example 44 (electrode density 1.75 g/cm³) were better than those of Comparative Example 16 (electrode density 1.50 g/cm³), Comparative Example 25 (electrode density 1.40 g/cm³), and Comparative Example 26 (electrode density 1.75 g/cm³). These results indicate that good electrode and battery properties can be achieved by using the resin in which the water-soluble resin (X) containing a copolymer of the hydroxyl group-containing monomer (a) and the acid group-containing monomer (b) as essential components further contains other monomer (c), and the aqueous latex (Y) according to the present invention.

As demonstrated by Example 45 and Comparative Example 27, or by Example 46 and Comparative Example 28, even when the negative electrode was made thicker, the peel strength, the capacity retention rate after 100 cycles at 45° C., and the capacity retention rate after 100 cycles at 0° C. in Example 45 (110 μm thick negative electrode mixture layer) and Example 46 (125 μm thick negative electrode mixture layer) were better than those of Comparative Example 27 (110 μm thick negative electrode mixture layer) and Comparative Example 28 (125 μm thick negative electrode mixture layer), each having the same mixture layer thickness. This indicates that even when the negative electrode is made thicker, good electrode and battery properties can be achieved by using the resin in which the water-soluble resin (X) containing a copolymer of the hydroxyl group-containing monomer (a) and the acid group-containing monomer (b) as essential components further contains other monomer (c), and the aqueous latex (Y) according to the present invention.

As demonstrated by Example 47 and Comparative Example 48, or by Example 29 and Comparative Example 30, even when a mixed active material of SiO negative electrode material and graphite was used, the peel strength, the capacity retention rate after 100 cycles at 45° C., and the capacity retention rate after 100 cycles at 0° C. in Example 47 (3.7 parts by weight of SiO negative electrode material) and Example 48 (5.3 parts by weight of SiO negative electrode material) were better than those of Comparative Example 29 (3.7 parts by weight of SiO negative electrode material) and Comparative Example 30 (5.3 parts by weight of SiO negative electrode material), each having the same mixed active material. This indicates that even when a mixed active material of SiO negative electrode material and graphite is used for the negative electrode, good electrode and battery properties can be achieved by using the resin in which the water-soluble resin (X) containing a copolymer of the hydroxyl group-containing monomer (a) and the acid group-containing monomer (b) as essential components further contains other monomer (c), and the aqueous latex (Y) according to the present invention.

1. A negative electrode binder composition comprising:
a water-soluble resin (X) comprising a copolymer of a hydroxyl group-containing monomer (a) and an acid group-containing monomer (b) as essential components; and an aqueous latex resin (Y), wherein
the copolymer has a weight average molecular weight of 700,000 or more as measured using an aqueous GPC measuring device and a swelling rate of 0 to 10% by weight after a dried film of the copolymer is immersed in a carbonate-based mixed solvent (ethylene carbonate (EC)/diethylene carbonate (DEC)=50/50 (wt)) at 45° C. for 72 hours.

2. The negative electrode binder composition according to claim 1, wherein the hydroxyl group-containing monomer (a) is any one or more selected from the group consisting of 2-hydroxyethyl acrylate, 2-hydroxypropyl acrylate, 3-hydroxypropyl acrylate, 2-hydroxybutyl acrylate, 4-hydroxybutyl acrylate, 2-hydroxyethyl methacrylate, 2-hydroxypropyl methacrylate, 3-hydroxypropyl methacrylate, 2-hydroxybutyl methacrylate, and 4-hydroxybutyl methacrylate.

3. The negative electrode binder composition according to claim 1, wherein the acid group-containing monomer (b) is neutralized with a basic composition or a light metal salt.

4. The negative electrode binder composition according to claim 1, wherein the acid group-containing monomer (b) is one or more selected from the group consisting of acrylic acid, methacrylic acid, maleic acid, monomethyl maleic acid, 2-carboxyethyl acrylate, 2-carboxyethyl methacrylate, maleic acid, and itaconic acid.

5. The negative electrode binder composition according to claim 1, wherein the water-soluble resin (X) further comprises one or more selected from the group consisting of acrylamide, methacrylamide, N-methylacrylamide, N,N-dimethylacrylamide, and N-hydroxymethylacrylamide.

6. The negative electrode binder composition according to claim 1, wherein a total content of resin components derived from the hydroxyl group-containing monomer (a) and the acid group-containing monomer (b) relative to a total amount of the water-soluble resin (X) is 5 to 80% by weight.

7. The negative electrode binder composition according to claim 1, wherein the one or more selected from the group consisting of acrylamide, methacrylamide, N-methylacrylamide, N,N-dimethylacrylamide, and N-hydroxymethylacrylamide have a content of 0 to 80% by weight.

8. The negative electrode binder composition according to claim 1, wherein the aqueous latex resin (Y) is one or more of a SBR, a styrene acrylate copolymer, and an acrylate copolymer.

9. The negative electrode binder composition according to claim 8, wherein the styrene acrylate copolymer is butyl acrylate.

10. The negative electrode binder composition according to claim 9, wherein a content of a styrene monomer-derived structural unit is 40 to 60% by weight and a content of a butyl acrylate monomer-derived structural unit is 20 to 40% by weight in a total amount of the styrene acrylate copolymer.

11. A negative electrode comprising the negative electrode binder composition according to claim 1 as a component.

12. The negative electrode according to claim 11, wherein a total content of a component derived from the water-soluble resin (X) and a component derived from the aqueous latex resin (Y) is 1.5% by weight or more and 5.5% by weight or less.

13. The negative electrode according to claim 11, further comprising a graphite-based material as a main active material, wherein the negative electrode has a volume density of 1.4 g/cm³ or more.

14. The negative electrode according to claim 11, wherein the negative electrode has a mixture layer having a thickness of 80 μm or more.

15. The negative electrode according to claim 11, further comprising a mixed active material of at least two or more of graphite-based materials and silicon-containing materials.

16. A secondary battery comprising the negative electrode according to claim 11.

17. A method for producing the negative electrode binder composition according to claim 1, the method comprising steps of:
kneading an aqueous slurry comprising at least an active material and the water-soluble resin (X); and
thereafter reducing a solid content concentration and mixing the aqueous latex resin (Y).
